(19) United States
(12) Patent Application Publication
(10) Pub. No.: US 2008/0016041 A1
(43) Pub. Date: Jan. 17, 2008

(54) SPREADSHEET-BASED RELATIONAL DATABASE INTERFACE

(76) Inventors: Brandon H. FROST, Portland, OR (US); Scott D. Stanton, Damascus, OR (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/777,588

(22) Filed: Jul. 13, 2007

Related U.S. Application Data
(60) Provisional application No. 60/830,810, filed on Jul. 14, 2006.

(51) Int. Cl. G06F 15/00; G06F 17/30; G06F 7/00; G06F 17/00

(52) U.S. Cl. 707/3; 715/212; 707/1; 707/100

(57) ABSTRACT

Multi-dimensional data in a relational database is accessed via a conventional spreadsheet application program such as MICROSOFT EXCEL®. The database can be accessed to either read information from the database and write it directly into the spreadsheet, or read information from the spreadsheet and write it directly into the database, i.e., without the data being stored in any intermediary data storage structure between the spreadsheet and database, thereby enhancing operational speed. Predetermined metadata is used to relate database organization to spreadsheet organization.

### CROSS-REFERENCE TO RELATED APPLICATION

The benefit of the filing date of U.S. Provisional Patent Application Ser. No. 60/830,810, filed Jul. 14, 2006, is hereby claimed, and the specification thereof is incorporated herein in its entirety by this reference.

### BACKGROUND OF THE INVENTION

1. Field of the Invention

The present invention relates generally to business data processing systems and, more specifically, to user interfaces and reporting tools for facilitating access to relational database information.

2. Description of the Related Art

Large business enterprises commonly use a number of computer systems, relational databases and software applications to store and process their data. Different departments within an enterprise, such as an accounting department, a sales and marketing department, a human resources department, a purchasing department, a production department, etc., typically use different database systems to store and process data relating to departmental functions. Although the enterprise's computers and database systems to which they have access may be intra-networked, there is typically no common or universal interface through which a departmental manager can access data relating to a different department, or through which a company executive can access data across the various departments. Rather, accounting data is generally accessed through one or more accounting application programs, sales data is generally accessed through sales application programs, and so forth.

To enable authorized individuals to more readily access data across various organizational boundaries in an enterprise, efforts have been made to aggregate or gather data from different databases. However, a problem that arises from such efforts is the lack of a convenient user interface or means through which users who may not have access to or familiarity with specialized application programs can view and manipulate the data.

There are a number of problems inherent in facilitating fast, convenient access to business data stored in relational database systems. Relational database systems are organized as collections of tables in which the tables contain both the data elements and the relationships between the tables. Relational database systems are well suited to creating records from series of transactions (commonly referred to as transaction processing), but they do not in and of themselves facilitate the kind of near-instantaneous analysis of large amounts of data that businesses demand for performance analysis and similar purposes. Report-writing tools exist for relational database systems, but they are slow and cumbersome to use to analyze large amounts of data. A major complicating factor is that business data and similar data that lends itself to storage in a relational database is multi-dimensional. A simplistic example of multi-dimensional business data for purposes of illustration might involve a cost accounting database in which each data value stored in the database represents some dollar value and has three dimensions associated with it: a department in which the cost was incurred; a time period during which it was incurred; and an account type to which the cost is attributed (e.g., office supplies, equipment, travel, etc.). In reality, business data commonly has many more than three dimensions. Multi-dimensional data (MDD) is organized in relational database tables in a manner that allows it to be accessed by a query specifying values of a combination of one or more of the dimensions.

It is known to store data in structures other than relational databases to facilitate fast analysis. The OLAP (On-line Analytical Processing) cube or OLAP cube-based system is perhaps the prime example of such a structure or non-relational database. An OLAP cube is, in the lexicon of database theory, an abstract representation of a projection of a relational database management system (RDBMS) relation. A data storage and retrieval system based upon OLAP cubes is well suited to fast analysis of MDD. It has been said that such OLAP cube-based systems are conceptually more like multi-dimensional spreadsheets than relational databases. Some commercially available OLAP cube-based systems can even service MICROSOFT EXCEL®, a popular spreadsheet application program, so that a user can populate an EXCEL spreadsheet report with information retrieved from the OLAP cube-based system. While exporting data from an OLAP cube-based system into a spreadsheet is relatively straightforward, updating data in an OLAP cube-based system from a spreadsheet is not, as cubes are somewhat static structures and therefore essentially must be rebuilt to represent updated or changed data. Some commercially available software products are known that provide libraries of spreadsheet functions or formulas that a user can embed in a spreadsheet to link cells to data in an OLAP cube system server. Commercially available software is also known that enables an OLAP cube-based system to “drill through” to a relational database, so that reports can be created that incorporate both OLAP cube-based and relational database table-based data.

It would be desirable to provide users with fast, convenient access to multi-dimensional data stored in relational database systems. The present invention addresses these problems and deficiencies and others in the manner described below.

### SUMMARY OF THE INVENTION

The present invention relates to a system, method and computer program product for accessing a relational database via a spreadsheet application program such as MICROSOFT EXCEL®. The database can be accessed to either read information from the database and write it directly into the spreadsheet, or read information from the spreadsheet and write it directly into the database, i.e., without the data being stored in any intermediary structure between the spreadsheet and database, thereby enhancing operational speed. The invention uses predetermined metadata that relates database organization to spreadsheet organization.

As the user interface comprises a conventional spreadsheet application program with which ordinary business users are familiar or comfortable, users can access data across an enterprise without having knowledge of specialized application programs, database administration, or unconventional codes or formulas to embed in the spreadsheet. Rather, the user uses the spreadsheet in essentially the conventional manner; once the metadata has been defined, the spreadsheet's connection with the database is essentially transparent to the user.

In accordance with an exemplary embodiment of the invention, the system accesses the database and accordingly writes to or reads from the spreadsheet when the system detects user interaction with the spreadsheet via a graphical user interface (GUI). The spreadsheet can be a suitable commercially available spreadsheet application program, such as EXCEL, with which a computer program product of the present invention interfaces. The above-referenced GUI with which user interaction is detected can be that which is inherent in EXCEL or, alternatively or in addition, a GUI comprising elements that extend or supplement the EXCEL GUI.

In response to detecting user interaction with the spreadsheet, the system first retrieves predetermined metadata that relates database organization to spreadsheet organization. The metadata is predetermined or predefined with respect to the user's interaction with the spreadsheet. That is, at some suitable time prior to the user's interaction with the spreadsheet, the user or other individual caused the metadata to be generated. For example, a suitable software tool can be provided that allows the user to specify, with respect to a spreadsheet, the meaning of each row, each column, and the cells defined by the intersections of those rows and columns. The meanings can correspond to the dimensions of the multi-dimensional data stored in the relational database.

The system then analyzes the retrieved metadata to allow it to identify the correspondence between data elements in the database and data elements in the spreadsheet without using any other information taken from the spreadsheet. In the exemplary embodiment the system identifies what dimensions correspond to what row or column of the spreadsheet, identifies the cells (referred to herein as junction cells or intersection cells) at the intersections of those rows and columns, and determines the database tables (and rows and columns within those tables) at which data elements corresponding to the identified spreadsheet cells are located.

An aggregation feature allows the metadata to define associations between a plurality of database elements and a lesser number of spreadsheet cells and methods by which the values of the database elements are to be aggregated. For example, the metadata may specify a number of different cost categories in the database that are to be summed or totaled before writing the total to a spreadsheet cell. In typical instances of use, it will be desirable to aggregate data in this manner so that voluminous information stored in the database can be more easily viewed and understood in the spreadsheet.

Analyzing the metadata as described above enables the system to identify the spreadsheet junction cells and database data elements that are to act as the sources and destinations for data to be moved between the spreadsheet and database, as well as any aggregations that are to be performed on the data. Once the metadata has been analyzed in this manner, the system accesses the identified data elements in the database to transfer information between the spreadsheet and the database. It should be noted that the information is transferred directly between the spreadsheet and database without using any intermediary data storage structures.

The following Detailed Description illustrates the invention more fully, through one or more exemplary or illustrative embodiments of the invention.

### BRIEF DESCRIPTION OF THE DRAWINGS

FIG. 1 illustrates accessing multi-dimensional data in a relational database via a conventional spreadsheet application program.

FIG. 2 is a block diagram of a computer system programmed to provide a spreadsheet-based relational database interface, in accordance with an exemplary embodiment of the invention.

FIG. 3 is a flow diagram illustrating a method for reading information directly from a relational database into a spreadsheet and writing information from a spreadsheet directly into a relational database, in accordance with the exemplary embodiment of the invention.

FIG. 4 illustrates report relationships among the four primary object classes that house metadata in an exemplary embodiment of the range-based tracking (RBT) software.

FIG. 5 illustrates a ReportSheet object in the exemplary embodiment.

FIG. 6 illustrates a ShadowRange object in the exemplary embodiment.

FIG. 7 illustrates spreadsheet horizontal and vertical ranges and a junction or intersection cell arising therefrom in the exemplary embodiment.

FIG. 8 illustrates the inheritance relationship among Marker classes in the exemplary embodiment.

FIG. 9 illustrates a Marker object in the exemplary embodiment.

FIG. 10 illustrates a TimeFieldMarker object in the exemplary embodiment.

FIG. 11 illustrates a DimensionMarker object in the exemplary embodiment.

FIG. 12 illustrates a JunctionCell object in the exemplary embodiment.

FIG. 13 illustrates a QueryDetector object in the exemplary embodiment.

FIG. 14 illustrates the inheritance relationship among QueryMarker classes in the exemplary embodiment.

FIG. 15 illustrates a QueryMarker object in the exemplary embodiment.

FIG. 16 illustrates a DimensionQueryMarker object in the exemplary embodiment.

FIG. 17 illustrates a TimeFieldQueryMarker object in the exemplary embodiment.

FIG. 18 is a database organization or schema diagram for the database in the exemplary embodiment.

FIG. 19 is a sequence diagram illustrating the read process in the exemplary embodiment.

FIG. 20 illustrates steps of the read process relating to identifying intersection or junction cells in the exemplary embodiment.

FIG. 21 illustrates steps of the read process relating to query markers in the exemplary embodiment.

FIG. 22 illustrates steps of the read process relating to the dimension query marker in the exemplary embodiment.

FIG. 23 illustrates steps of the read process relating to building distinct sets of query markers in the exemplary embodiment.

FIG. 24 illustrates steps of the read process relating to determining if query marker collections are unique or already exist in the exemplary embodiment.

FIG. 25 illustrates steps of the read process relating to database query generation in the exemplary embodiment.

FIG. 26 illustrates steps of the read process relating to building a SQL query string in the exemplary embodiment.

FIG. 27 illustrates steps of the read process relating to placing multi-dimensional data values in corresponding spreadsheet locations in the exemplary embodiment.

FIG. 28 illustrates is a sequence diagram illustrating the write process in the exemplary embodiment.

FIG. 29 illustrates steps of the write process relating to processing the junction cells and generating and executing SQL queries against the database.

### DETAILED DESCRIPTION OF AN EXEMPLARY EMBODIMENT

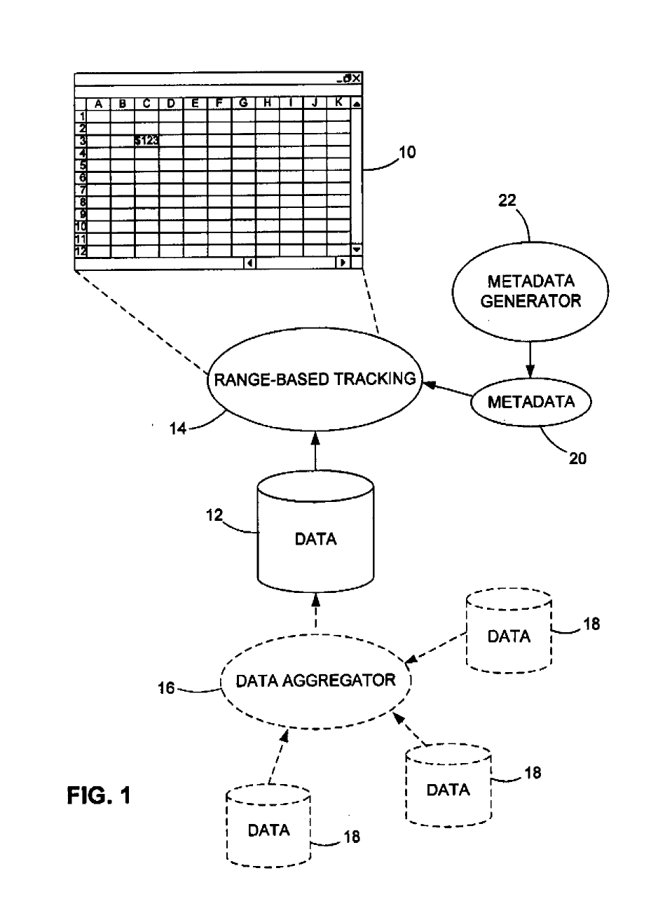

As conceptually illustrated in FIG. 1, a spreadsheet 10, such as the popular MICROSOFT EXCEL®, forms the primary portion of the user interface of a system through which a user can access a relational database 12. As described in further detail below, in an exemplary embodiment of the invention this portion of the user interface is not merely EXCEL-like, but actually incorporates, extends or otherwise interfaces with an instance of the EXCEL application program (or relevant portions thereof). A process 14 that is referred to in this patent specification (“herein”) for purposes of convenience as “range-based tracking” (RBT) controls the transfer of information between spreadsheet 10 and database 12. Through spreadsheet 10 and RBT process 14, a user can access database 12 to read information from database 12 and write information to database 12. Note that information is transferred directly between spreadsheet 10 and database 12 without the data being stored in any intermediary data storage structure or undergoing any intermediary transformation, thereby enhancing operational speed. In a multi-user system, each user can access information in database 12 through a separate instance of spreadsheet 10 on which that user is working, and information changed by one user is nearly instantaneously accessible to another user.

The information that is stored in database 14 can be obtained from any suitable source. For example, a data aggregator 16 can aggregate or gather the information from disparate sources 18, such as various other databases or computing systems within a business enterprise. Thus, the invention can provide an enterprise-wide user interface in the convenient and familiar form of an EXCEL spreadsheet, through which personnel can access data across the enterprise's various organizational units and their associated data storage systems.

As the structure and operation of such spreadsheet application programs and the structure and use of electronic spreadsheets are well understood to persons skilled in the art to which the invention relates, they are not described herein except as they may specifically relate to features of the invention. It can be noted generally, however, that an electronic spreadsheet is used by entering information into and reading information from graphical cells defined by intersections of graphical rows and columns. Typically, the spreadsheet labels its rows with numbers and its columns with letters, as shown in FIG. 1, and a cell at the intersection of a row and column is referred to by the concatenation of its column and row label, such as “C3.” The invention relates to transferring information between cells in spreadsheet 10 and elements in database 12. An important aspect of the invention is determining a correspondence between the cells in spreadsheet 10 and elements in database 12, so that the sources and destinations to transfer data from and to can be determined in any instance.

As described below in further detail, the invention is based in part upon the use of predetermined metadata 20 that relates database organization to spreadsheet organization. In essence, metadata 20 defines, among other things, which data elements in database 14 correspond to which cells in spreadsheet 10. Metadata 20 is “predetermined” or “predefined” in that it is generated prior to the time a transfer of data between spreadsheet 10 and database 12 is initiated. A suitable metadata generator 22 can be provided as a (software) tool to assist in generating the metadata. Metadata generator 22 can include a suitable graphical user interface (GUI) through which the user is guided through a process of selecting correspondences between ranges of cells in spreadsheet 10 and data elements in database 12. The ranges of data elements in database 12 can correspond to multi-dimensional data (MDD) dimensions and be organized as tables in database 12, in accordance with conventional relational database organization. Although not indicated in the conceptual illustration of FIG. 1 for purposes of clarity, once generated, metadata 20 can be stored or persisted in a manner similar to that of the data in database 12 in preparation for a data transfer.

An appreciation of how the present invention operates can perhaps best be gained through a straightforward example of how the invention can be used. In the following hypothetical scenario or example, a financial accountant (user) is faced with the problem of how to view and then change some dollar values for a department in the accountant's business organization. In this example, the accountant wishes to view the amount of money spent in an account that is referred to by the name “Paper Supplies” and by the account number “4004” in the organization's Information Technology department, which is referred to by the department number “00IT”, in the previous month. For purposes of illustration, in this example the information that the user wishes to view is a single dollar value; in actual business practices, accountants typically wish to view multiple accounts for a department all at once.

The accountant or an associated person charged with setting up the system in preparation for solving the accountant's problem begins by generating metadata 20 using metadata generator 22 or other suitable means. An EXCEL spreadsheet that has been configured to contain dollar values or similar information is also referred to herein as a “report.” (Although the term “spreadsheet” is used herein for convenience to refer, depending upon the context, to either the spreadsheet application program itself or the spreadsheet document on which the user is working, it should be noted that in the lexicon of EXCEL, the term “Worksheet” refers to the spreadsheet document or page of a multi-worksheet document (“Workbook”) on which the user is working; thus, the term “Worksheet” is alternatively used herein in the latter context.) The user configures the spreadsheet (e.g., EXCEL Worksheet) to define a report by assigning dimensions to the Worksheet. In this example the data has three dimensions: department, account, and time.

The dimensions can be assigned to any suitable combination of Worksheet rows and columns in any suitable orientation. For example, the user can assign the department dimension to the entire Worksheet, the account dimension to the rows of the Worksheet, and the time dimension to the columns of the Worksheet. In the exemplary embodiment of the invention, metadata generator 22 provides a graphical user interface that guides the user through this process of assigning dimensions. However, in other embodiments of the invention, metadata 20 can be generated in any other suitable manner.

Note that metadata 20 is not embedded in the Worksheet; rather, it exists separately from the Worksheet (and spreadsheet application program itself). This provides the framework that allows specific dimensional items to be assigned later.

At this point in the process, the Worksheet is blank. The Worksheet is essentially a conventional EXCEL Worksheet, and the user can use the Worksheet in the same manner as any conventional EXCEL Worksheet. That is, the user is free to type in any content or header information that the user wishes to see in the report. Continuing the example, the user must specify (or attach) specific dimensional items to the report within the boundaries of the previously defined axes. For example, the user may choose row 3 in the Worksheet and assign account 4004 to that row. Then, the user may choose column C and assign the previous month's period total to that column. Finally, the user may assign department 00IT to the entire Worksheet. As described in further detail below, any dollar value retrieved from database 12 is qualified or attached to all three dimensions. The resulting metadata 20 can be stored or persisted in memory or other data storage so that it can be accessed when information is to be read from database 12 into spreadsheet 10 (i.e., the EXCEL Worksheet in this example).

When RBT process 14 determines that the user is interacting with spreadsheet 10 in a manner that indicates that data is to be read from database 12 into spreadsheet 10, RBT process 14 determines, in the manner described in further detail below, that this report needs a single dollar value and that the number should be placed into cell C3 as defined by the intersection of the “Paper Supplies” row and the “previous month” column. The RBT process 14 reads the value from database 12 and places it in cell C3, qualifying the value on the Worksheet-level 00IT department as well as the row and column assignment. The displayed Worksheet reflects the retrieved value in cell C3, and the user can then manipulate the Worksheet in the conventional manner.

Thus, for example, the user can change the dollar value in the Worksheet cell by typing in a new value. In response to this user interaction (or as otherwise indicated through a user-input command), RBT process 14 uses metadata 20 as defined above to determine that the new value in cell C3 is attached to all three of the specified dimensional items and to determine where in database 12 the new value in cell C3 should be stored. The RBT process 14 then writes the value into the determined location in database 12. These read and write processes are described in further detail below.

An Exemplary Computer-Based System

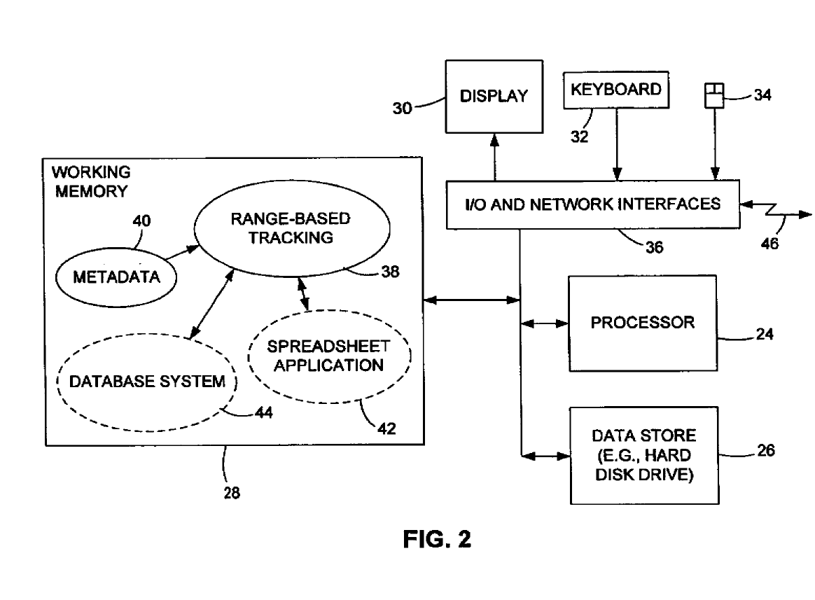

In the above-described example, the user interacts with a suitable computer-based system. For example, such a system can comprise one or more computers, such as networked server and client computers. The system of the present invention can be arranged in any suitable manner, and its elements can be distributed over any suitable number and type of computing devices and equipment. As illustrated in FIG. 2, in the exemplary embodiment a suitable computer includes a processor 24, data storage device 26 such as a hard disk drive, memory 28 for program and data storage under the control of processor 24, display 30, keyboard 32, mouse 34, and any other elements of the types commonly included in business and personal computers, such as network and input/output interfaces 36 through which display 30, keyboard 32, mouse 34 and other user interface devices communicate with the remainder of the system. Note that processor 24 and the memory 28 in which programs are executed and data is stored together define a processing system that can be programmed with software to cause the system to effect various functions as defined by that programming.

Accordingly, the system in an operational state further includes the following software elements, which are described in further detail below: range-based tracking (RBT) software 38, metadata 40, a spreadsheet application program 42 such as EXCEL, and a database system 44. Note that although these software elements are conceptually shown for purposes of illustration as residing in memory 28, persons skilled in the art to which the invention relates can appreciate that such program and data elements do not in actuality necessarily reside in memory simultaneously or in their entireties. Rather, such software elements or portions thereof can be retrieved on an as-needed basis under control of processor 24 from sources such as data storage device 26 or remote devices (via a network connection 46), in accordance with conventional computing system operational principles and protocols. Similarly, they may not in actuality be as distinct as conceptually indicated but rather may share common elements. Other hardware and software elements of the types commonly included in computing systems, such as an operating system and system administration utilities, are included but not shown for purposes of clarity. It should also be noted that combinations of the software elements described herein and the computer-usable media on which they are stored or recorded, such as data storage device 26, memory 28, a portable disk (e.g., CD-ROM or DVD), etc., constitute “computer program products” as that term and similar terms are used in the patent lexicon.

As indicated in FIG. 2, RBT software 38 interfaces with spreadsheet application program 42 and obtains metadata 40 as needed to perform the read and write processes with respect to database system 44. (Metadata generator 22 or other means for providing metadata 40 is not shown in FIG. 2 for purposes of clarity. Metadata 40 can be generated or otherwise provided in any suitable manner.)

Although a user can operate the system by using display 30, keyboard 32, mouse 34 and other user interface devices, it is also contemplated that the illustrated computer be a server, and that users interact with the server computer through remote client computers (not shown) having similar user interface devices via network connection 46. The user uses such user interface devices in accordance with standard GUI and window-based software conventions to interact with GUI elements arising from the operation of application programs. For example, the user can use mouse 34 to select or “click on” displayed GUI elements such as graphical control buttons, “drag” graphical objects, “scroll” through windows, etc. In addition, a user can use keyboard 32 or a similar keyboard (not shown) of a remote client computer to enter text into appropriate boxes, cells or other graphical regions. Specifically, a user interacts with spreadsheet application program 42, such as EXCEL, in this well-known manner, and may similarly interact with aspects of RBT software 38. Display 30 or a similar display of a remote client computer displays the spreadsheet (e.g., EXCEL Worksheet) on which the user works, in accordance with the operation of spreadsheet application program 42.

Overview of the Exemplary Method (Read and Write Processes)

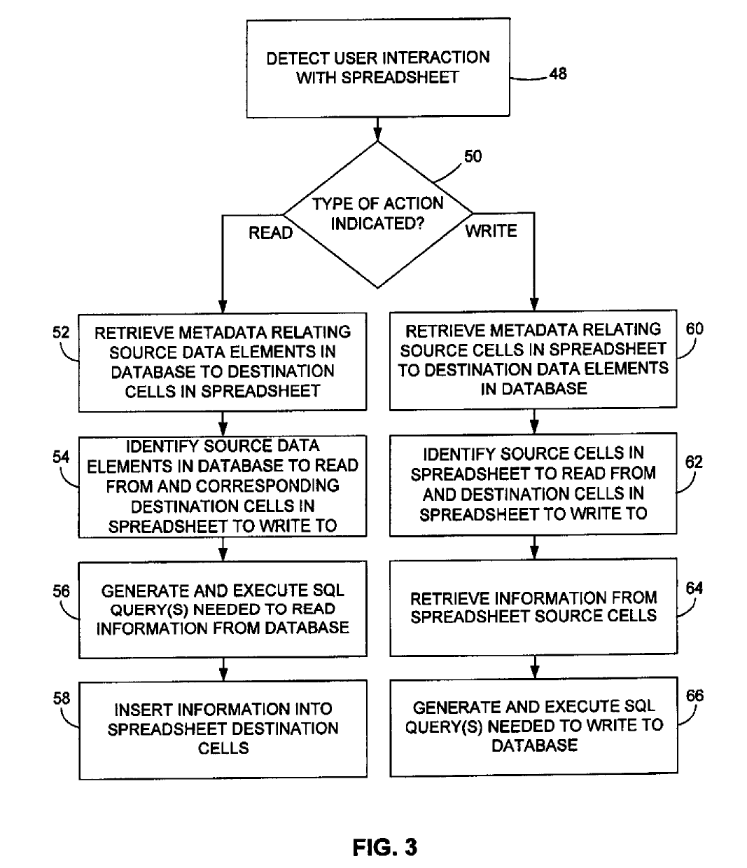

The read and write processes associated with the exemplary embodiment of the invention are illustrated in FIG. 3. At step 48, RBT software 38 detects user interaction with the GUI relating to spreadsheet 10 (FIG. 1). For example, the interaction can be that which the EXCEL spreadsheet application program 42 (FIG. 2) flags as an “EXCEL event” and which thus can be detected by external software such as RBT software 38. An example of an EXCEL event is when a user enters a value in a cell. Alternatively, the interaction can involve the user clicking on a button or other graphical control (not shown) provided by RBT software 38 as an extension to the EXCEL native GUI. This detection of user interaction triggers the remainder of the read or write process.

At step 50, RBT software 38 determines whether the detected interaction indicates whether a read process or write process is to be performed with respect to database system 44 (FIG. 2). A read process involves transferring data from database system 44 to spreadsheet application program 42, and a write process involves transferring data from spreadsheet application program 42 to database system 44.

If a read process is indicated, then at step 52 RBT software 38 retrieves the metadata that relates the source database elements to the destination spreadsheet cells. More specifically, the metadata enables the read process to determine where in the spreadsheet there are data-containing cells. Data-containing cells are those cells at the intersections or junctions of rows and columns for which the metadata indicates dimensions have been assigned. (Recall in the above-described example that the “department” dimension was assigned to the entire spreadsheet (EXCEL Worksheet), the “account” dimension was assigned to the rows, and the “time” dimension was assigned to the columns.) The metadata also conveys any aggregation information. That is, the metadata can indicate in some instances that a group of two or more data elements are to be combined in a manner that allows them to be placed into a smaller number of spreadsheet cells. For example, they can be added or summed together, and the sum placed into a spreadsheet cell. As indicated by step 54, RBT software 38, taking into account any aggregation information, identifies the source data elements to be read from and corresponding destination spreadsheet cells to be written to. At step 56, RBT software 38 uses the metadata to generate a standard query language (SQL) query and executes the SQL query against database system 44. Database system 44 responds to the SQL query in the conventional manner by returning data. At step 58, RBT software 38 inserts the returned data into the destination spreadsheet cells, i.e., the above-referenced intersection or junction cells.

If at step 50 it is determined that a write process is indicated, then at step 60 RBT software 38 retrieves the metadata that relates the source spreadsheet cells to the destination database elements. At step 62, and as described below in further detail, in the exemplary embodiment some of the information that is produced during the read process (referred to as “support metadata”) is used in conjunction with the metadata during the write process to determine where the intersection or junction cells occur in the spreadsheet and whether the data in each such cell can be persisted back to the database. At step 64, RBT software 38 reads the data from the intersection or junction spreadsheet cells. At step 66, RBT software 38 uses the metadata to generate a SQL query and executes the SQL query against database system 44. Database system 44 stores or persists the data in response to the SQL query in the conventional manner.

Metadata Data Structures Common to Read and Write Processes

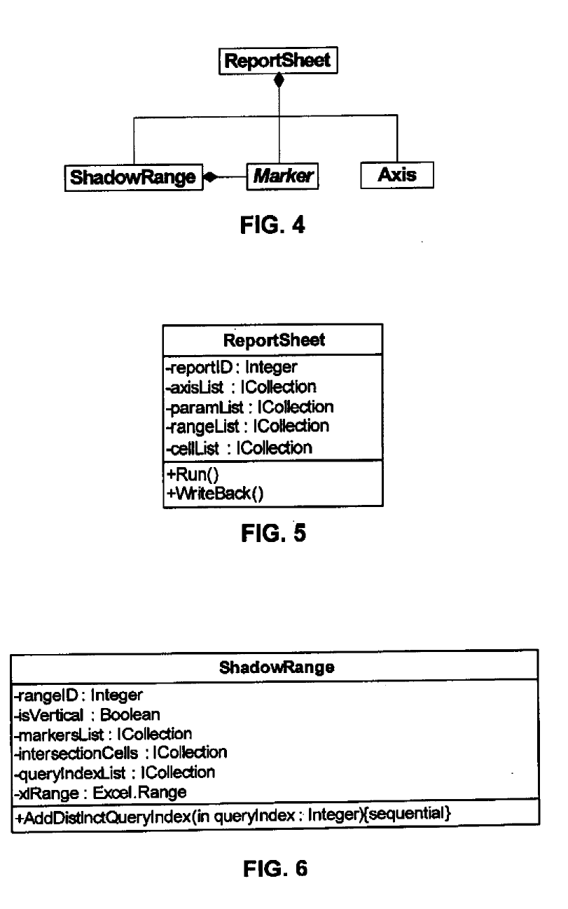

The RBT software 38 is preferably implemented or structured as a code base of object-oriented classes, data structures, algorithms, etc., using the MICROSOFT .NET® framework. In the exemplary embodiment, the read and write processes both use objects of the same four primary classes that house metadata 40 in memory 28 (FIG. 2): ReportSheet; Axis; ShadowRange; and Marker. The reporting relationships among these classes is indicated in standard Unified Modeling Language (UML) notation in FIG. 4. A ReportSheet object is the container for objects of the other three classes. A ShadowRange object provides information about a specific “range” (i.e., a horizontal or vertical grouping of cells) within the EXCEL Worksheet. A Marker object assigns a ShadowRange to an object or collection of objects such as dimensional item, a group of dimensional items, or a time period. An Axis object provides information about the horizontal and vertical axes in an EXCEL Worksheet, such as what types of things (e.g., what data dimensions) can be assigned to horizontal and vertical axes).

A ReportSheet object contains collections of the other objects. It also stores metadata that applies to an entire EXCEL Worksheet. It has the structure shown in FIG. 5. (Per UML conventions, familiar to persons skilled in the art to which the invention relates, the structure shown in FIG. 5 indicates the data and methods contained in the object.) There exists one Report Sheet object for each Excel worksheet that is being read from or written into.

Each ReportSheet object contains at least the following data: reportId, which is an Internal unique ID; axisList, which is a collection of Axis objects that specifies which dimensions and/or time field is assigned to either the vertical (columnar) or horizontal axis (rows) in the Worksheet; paramList, which is a collection of Marker objects that are assigned at the sheet level (anything in this list applies to the entire sheet); and rangeList, which is a collection of ShadowRange objects. Each ShadowRange object attaches to a specific place in the worksheet.

The Report Sheet object also contains methods that encapsulate behavior and are the launch point for both the read and write processes: Run, which is a publicly accessible method that starts the read process; and WriteBack, which is a publicly accessible method that starts the write process.

The Axis object provides information about the horizontal and vertical axes in an EXCEL Worksheet. It has the structure shown in FIG. 6. While there are only two axes in an EXCEL spreadsheet, there exists one Axis object in the report's collection for every dimension plus time field. Each Axis object contains at least the following data: axisID, which is an internal unique ID; is Vertical, which has a value of True if this axis object applies to the vertical Worksheet axis and False if it applies to the horizontal Worksheet axis; is TimeField, which is True if this axis represents the time component; dimensioned, which stores the unique ID of the dimension this axis object represents if is TimeField is False, and is not used if is TimeField is True; and dimensionName, which stores the name of the dimension this axis object represents if is TimeField is False, and is not used if is TimeField is True.

The ShadowRange object provides information about a specific range within the EXCEL Worksheet. The exact range is tracked by the xlRange variable that references an EXCEL range object. This object primarily addresses the need for the read process to obtain from the metadata information about the specific cells in the Worksheet in which the MDD is to be placed, i.e., its destination location, as well as the need for the write process to obtain from the metadata information about specific cells in the Worksheet from which the MDD is to be obtained, i.e., its source location. The Shadow Range object contains at least the following data: rangeID; is Vertical; xlRange; markersList; intersectionCells; and queryIndexList.

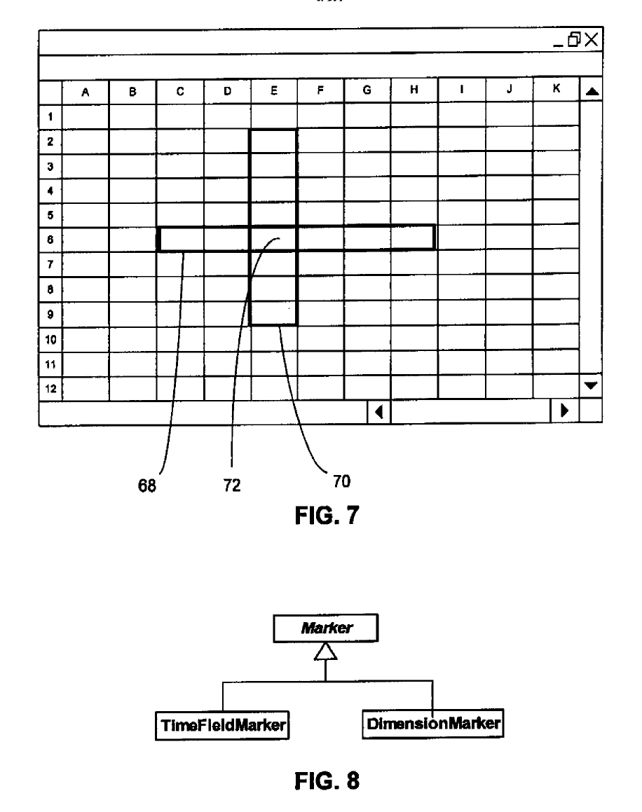

The rangeID is an internal unique ID for the object. The value of is Vertical is True if this range is tracking a vertical (columnar) EXCEL range and False if it is a row range. The xlRange is the true EXCEL range object (this ties the Shadow Range object to the actual location in the Worksheet). The markersList is a collection of Marker objects that are assigned to this Shadow Range object. It applies only to this range and is limited to dimension marker or time field marker types as defined in the Axis objects. Multiple marker object can be assigned to this range. The intersectionCells are a collection of the JunctionCell objects (described below) that define every point where this shadow range intersects another opposite shadow range. Intersection cells (also referred to as junction cells) identify the exact locations where specific MDD values are to be placed. An exemplary row range 68, column range 70 and junction cell 72 are shown in FIG. 7 (highlighted in bold line for purposes of emphasis; the highlighting is not intended to illustrate appearance on a screen display). The queryIndexList is a distinct collection of numbers that identify the dynamically generated queries that apply to this shadow range. The ShadowRange object also encapsulates a behavioral method, AddDistinctQueryIndex, which is a publicly accessible method that helps maintain the uniqueness of the queryIndexList. It is used as described below with regard to the read process steps.

Marker objects assign a range to an object or collection of objects and can apply to either the entire report sheet level or can apply just to a specific shadow range. Markers that apply to the entire report sheet affect all junction cells in that sheet. Markers that apply to a single shadow range only affect junction cells within that shadow range. Marker objects are organized using an object oriented design principle called inheritance so they can be treated polymorphically. It should be understood that when an object is referred to as a Marker it can be of either the sub-class type TimeFieldMarker or DimensionMarker. Both TimeFieldMarker and DimensionMarker extend the Marker base class, which is abstract, as shown in FIG. 8.

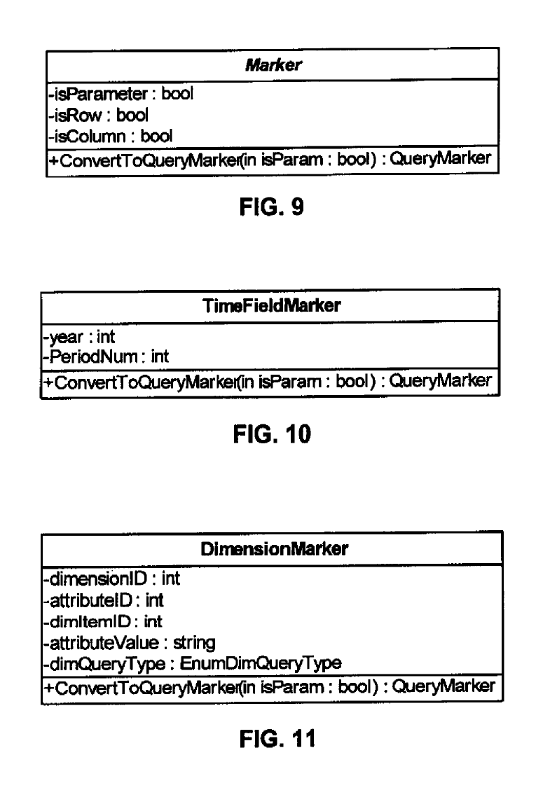

DimensionMarker objects assign a shadow range or report sheet to this specific dimensional item or a specified aggregate of a group of dimensional items. TimeFieldMarker objects assign a shadow range or report sheet to a specific time field. The combination of all Marker objects at the report sheet and shadow range level primarily address the need of the read process to obtain contextual information from the metadata about the MDD stored in the database, i.e., the source location, and to obtain aggregation information from the metadata about how to combine MDD. The combination of Marker objects at the report sheet and shadow range level also address the need for the write process to obtain from the metadata information about specific cells in the database where the MDD is to be stored, i.e., its destination location. The structure of the Marker object is shown in FIG. 9. It contains at least the following data: is Parameter; is Row; and is Column. The is Parameter is True if this marker object applies to the report sheet as a whole. Storing this value here allows the marker object to know within itself if it applies to the report sheet or a single shadow range. The is Row is True if this marker object is not a report sheet level marker and if it applies to a horizontal shadow range. The is Column is True if this marker object is not a report sheet level marker and if it applies to a vertical shadow range. The Marker object also encapsulates the method ConvertToQueryMarker, which is an abstract method that is used as part of the read process algorithm to produce a unique QueryMarker, as described in further detail below with regard to the read process steps.

The TimeFieldMarker object assigns a shadow range or report sheet to a specific time component and has the structure shown in FIG. 10. Each TimeFieldMarker object contains the following data: year; and periodNum. The year is the year to which the MDD applies. MDD is described below in further detail with regard to the MDD model upon used in the database. In the database data model, a year is divided up into multiple but equal periods. The periodNum is a specific period number to which the MDD value being read or written applies; it defines the period in context of a year. The model is flexible enough to allow for any granularity of time representation within a year. The TimeFieldMarker object also encapsulates the ConvertToQueryMarker method, which converts the values stored in this object into a unique TimeFieldQueryMarker object that is used as supporting metadata during the execution of the read and write processes.

The DimensionMarker object assigns a shadow range or report sheet to this specific dimensional item or a specified aggregate of a group of dimensional items. An example of a specific dimensional item in a fictitious “Factory” dimension would be “Widget Factory #2”. An example of an aggregate group would be all factories in the “West” region. The structure of the DimensionMarker object is shown in FIG. 11. Each DimensionMarker object contains at least the following data: dimensioned, which is the unique ID of the dimension that this DimensionMarker applies to; dimQueryType, which specifies how the MDD values are to be treated for either the read or write process for the specified dimension in the dimensionID variable; dimItemID; and attributeId. The dimQueryType can assume one of three possible values: Single Dimensional Item (attach to a specific single dimensional item within the dimension; Rollup Attribute (attach to an aggregate (summation of multiple dimensional items) based on an attribute value within the dimension); and Rollup Dimension (attach to the summation of all dimensional items within the dimension). The dimItemID contains the specific unique ID for the dimensional item if dimQueryType is Single Dimensional Item. The attributeId contains the specific unique ID for the attribute used to calculate the aggregate ff dimQueryType is Rollup Attribute. The attributeValue contains the unique value of the attribute specified in attributeId if dimQueryType is Rollup Attribute. The DimensionMarket object also encapsulates the method ConvertToQueryMarker, which converts the values stored in this object into a unique DimensionQueryMarker object that is used as supporting metadata during the execution of the read and write processes.

In addition to the four above-described main classes that house metadata, support classes JunctionCell, QueryDetector, QueryMarker, DimensionQueryMarker, and TimeFieldQueryMarker house finer-grained metadata or are otherwise used in the operation of the read and write process.

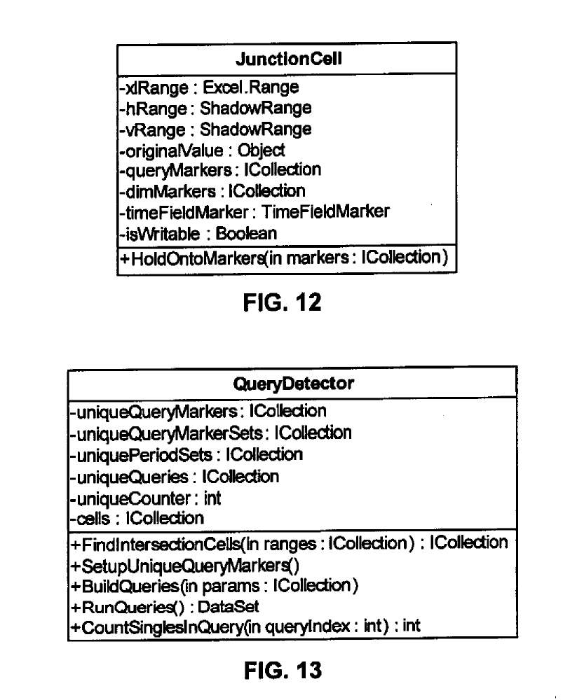

A JunctionCell object encapsulates the concept of an intersection cell (cells intersecting on vertical and horizontal axis). It helps identify a unique collection of QueryMarker objects to produce the MDD value for this cell. Generated when analyzing the shadow range objects and report sheet objects, it contains information about a specific cell in the worksheet. The structure of the JunctionCell object is shown in FIG. 12. Each JunctionCell object contains at least the following data: xlRange, which is a reference to the actual Excel Range object which is a single cell in the worksheet; hRange, which is the single horizontal shadow range that includes this cell; vRange, which is the single vertical shadow range that includes this cell; queryMarkers, which is a collection of QueryMarker objects that together determine the database associations for this cell; dimMarkers, which is a collection of the parent DimensionMarker objects from both shadow ranges for this cell; timeFieldMarker, which is the single TimeFieldMarker object for this cell; is Writable, which is True if the MDD value in this cell can be written back to the database and is used by the write process; and originalvalue, which holds the value read out of the database, is filled at the end of the read process, and is used during the write process to help distinguish between inserting and updating. In addition, the HoldOntoMarkers method is used by JunctionCell to fill the dimMarkers collection as well as the timeFieldMarker variable.

The QueryDetector object tracks many pieces of information needed to generate all of the database queries for the report sheet. It also contains a lot of the process logic for the read process. The structure of the QueryDetector object is shown in FIG. 13. Each QueryDetector object contains at least the following data: uniqueQueryMarkers, which is a collection of unique QueryMarker objects across the entire report sheet (and prevents the duplication of identical QueryMarker objects); uniqueQueryMarkerSets, which is a collection of unique sets of QueryMarker objects (note that each set will determine a different database query); uniquePeriodSets, which is a collection of the period numbers associated with each database query (or unique set of QueryMarker objects); uniqueQueries, which is a collection of the database queries determined by the process algorithm; uniquecounter, which is a number that starts at 1 and increases by 1 each time a QueryMarker is created (and thus helps maintain the uniqueness of QueryMarkers); and cells, which is a collection of all the JunctionCell objects in the report sheet. The QueryDetector object also contains the following behavioral methods that are important to the read process algorithm. FindIntersectionCells, which walks all shadow ranges in the report sheet and finds all places where a junction cell occurs (and builds the cells collection in this object as well as the intersectionCells collection in the shadow range object); SetupUniqueQueryMarkers, which builds the unique set of QueryMarkers for each junction cells; BuildQueries, which uses metadata collected and internal logic to generate database queries; RunQueries, which executes the queries against the database and retrieves the results; and CountSinglesInQuery, which returns a number that specifies how many dimensions for a given query are of the DimQueryType of Single Dimensional Item.

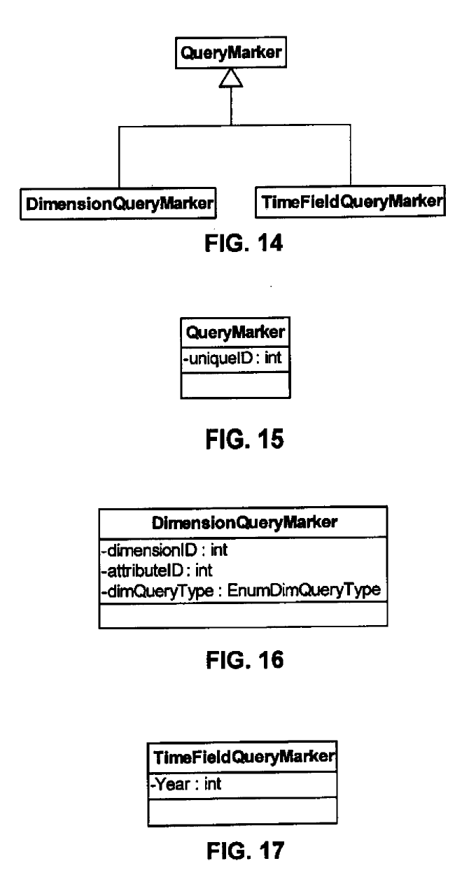

The read process produces QueryMarker objects resulting in a collection of unique queries to read data from the database. While QueryMarker objects are similar to the Marker objects, they differ in these ways: (1) Unlike other Marker subclasses, QueryMarkers contain a much smaller subset of the data; and (2) JunctionCells store unique combinations of QueryMarker objects to help determine distinct database queries. They do not apply to ShadowRange or ReportSheet objects. Using the object-oriented design principle of inheritance, QueryMarker can be treated polymorphically, since as a QueryMarker it could assume either of the sub-class types TimeFieldQueryMarker or DimensionQueryMarker. Both TimeFieldQueryMarker and DimensionQueryMarker extend the QueryMarker base class, which is abstract, as illustrated in FIG. 14.

The structure of the QueryMarker is shown in FIG. 15. Each QueryMarker object contains at least a uniqueID, which is a unique number that is generated at creation time for every DimensionQueryMarker and TimeFieldQueryMarker. The read process algorithm (described below) requires uniqueness across all of the QueryMarkers in order to determine the minimum number of database queries needed to get all of the MDD values in the report sheet, for best performance. This distinct number is a straightforward way to guarantee uniqueness, but any other suitable way can be used.

A DimensionQueryMarker object contains a subset of information copied from the DimensionMarker object to be able to determine a database query. The structure of the DimensionQueryMarker is shown in FIG. 16. Each DimensionQueryMarker object contains the following: dimQueryType; dimensioned; and attributeId. The dimQueryType is the same as the DimensionMarker object. It specifies how the MDD values are to be treated for either the read or write process for the specified dimension in the dimensionID variable. It is always one of three possible values: Single Dimensional Item (attach to a specific single dimensional item within the dimension; Rollup Attribute (attach to an aggregate (summation of multiple dimensional items) based on an attribute value within the dimension); or Rollup Dimension (attach to the summation of all dimensional items within the dimension). The dimensionID is the unique ID of the dimension that this DimensionQueryMarker applies to. If dimQueryType is Rollup Attribute, the attributeId contains the specific unique ID for the attribute used to calculate the aggregate

A TimeFieldQueryMarker object contains just enough information from its parent TimeFieldMarker object to be able to determine a database query. The structure of the TimeFieldQueryMarker object is shown in FIG. 17. Each TimeFieldQueryMarker object contains at least the year to which the MDD applies. The use of TimeFieldQueryMarker will become more apparent with reference to the MDD model, described below, on which the database is based.

The Multi-Dimensional Data (MDD) Model

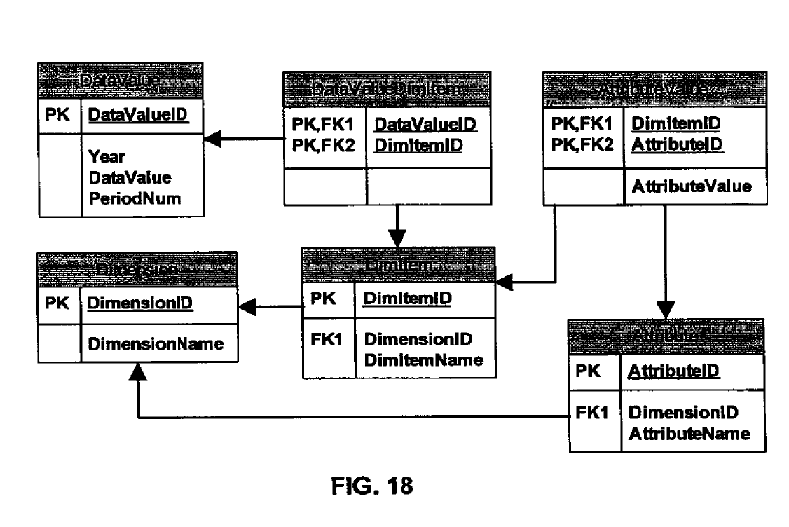

The read and write processes operate on the basis of the exemplary MDD model shown in FIG. 18. This model represents how database 12 (FIG. 1) is organized. As described above with regard to FIG. 1, although the data in database 12 can be obtained in any suitable manner, it is contemplated that in some instances it will be aggregated or gathered from various other databases 18 within the business enterprise. In such instances, the aggregated MDD is uniformly stored in database 12 in accordance with this model, regardless of how the data was organized in the original databases 18 from which it was taken.

As described above, the purpose of the MDD organization allows different data values to be related to different combinations of dimensional items within the database. The exemplary organization of the model also accomplishes three other tasks. First, it allows data values to be related to multiple combinations of dimensional items. For example, data value gamma could be related to three other dimensional items while data value delta could be related to five other dimensional items. Second, it places no limits on the number of periods (PeriodNum) that can be stored in the database. Third, the attribute values associated with dimensional items allow those dimensional items to be aggregated. For example, numerical data values can be summed based on a particular attribute value. As shown in FIG. 18, the MDD model includes the following tables: Dimension Table; DimItem Table; DataValue Table; DataValueDimItem Table; Attribute Table; and AttributeValue Table.

The Dimension Table stores a list of dimensions: DimensionID, which is the unique identifier and primary key; and DimensionName, which is the visual name of the dimension.

The DimItem Table stores a list of dimensional items that apply to one and only one of the dimensions in the Dimension Table. This table contains all dimensional items for all dimensions in the Dimension Table: DimItemID, which is the unique identifier and primary key; DimItemName, which is the specific name for this item; and DimensionID, which is the dimension to which this item applies.

The DataValue Table stores the actual data values. The type of data values is not limited to monetary values but could also include any other suitable type of data, such as textual data. The table contains: DataValueID, which is the unique identifier and primary key; DataValue, which is the location where the real-world data is stored; Year, which is the year to which this data value relates; and PeriodNum, which is the period to which this data value relates.

The DataValueDimItem Table table associates the actual value in DataValue with its related dimensional items in the DimItem table. There could be many rows in this table for a single actual value depending upon the number of dimensions associated with the data value. All rows in this table for a single DataValueID belong together and give a full picture of the relationships for that data value. The table contains: DataValueID, which is a foreign key to the DataValue table; and DimItemID, which is a foreign key to the DimItem table.

The Attribute Table defines the categories contained in a particular dimension. Each attribute row applies to one and only one dimension. The table contains: AttributeID, which is the unique identifier and primary key; DimensionID, which is a foreign key to the dimension table (and thus associates the attribute with the correct dimension); and AttributeName, which is the visual name of the attribute.

The AttributeValue Table stores the specific category types for an attribute attached to a particular dimensional item. It contains: AttributeID, which is a foreign key to the Attribute table and specifies which attribute this attribute value applies; DimItemID, which is a foreign key to the DimItem table and specifies which dimensional item this attribute value applies; and AttributeValue, which is the category type for the dimensional item and attribute.

The Read Process

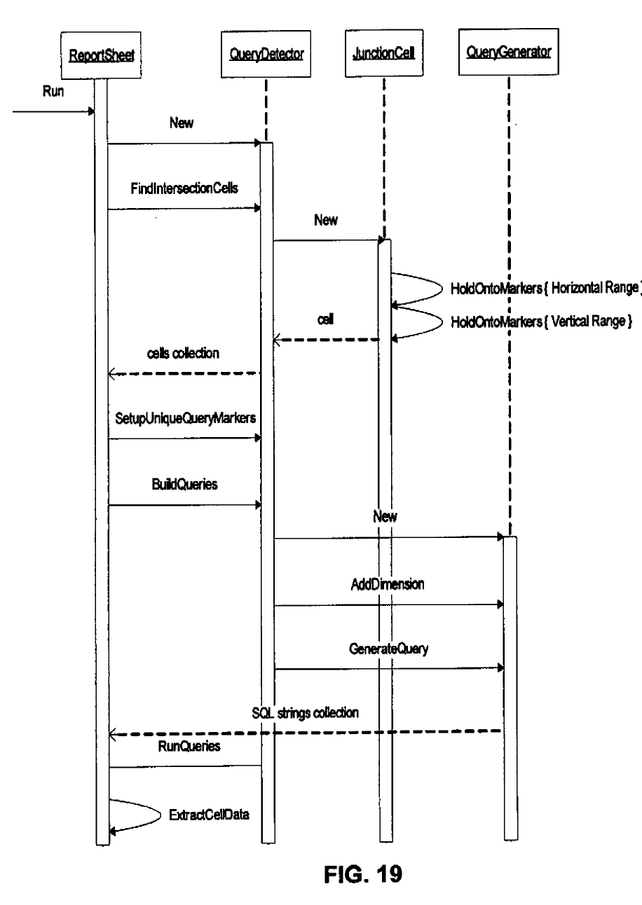

The read process, described above at an overview level with regard to steps 52, 54, 56 and 58 in FIG. 3, operates upon a combination of three things: an existing spreadsheet (e.g., EXCEL Worksheet) in which the actual data values are to be displayed; actual MDD values (i.e., the source data to be read) stored in a database that conforms to the MDD model (FIG. 18); and predefined metadata in the form of ReportSheet, ShadowRange, Marker, and Axis objects, which are analyzed by the read process. The exemplary read process is illustrated by the sequence diagram of FIG. 19. The read process beings when the Run method of the ReportSheet object (FIG. 5) is executed. This method controls the read process. (Note that in the previous sentence and in similar descriptions herein the term “method” is used its object-oriented programming context rather than in the more generalized context of a “method” or “process” embodiment of the present invention.) An instance of a QueryDetector object is created (FIG. 13).

The QueryDetector constructor initializes variables and creates new instances of supporting metadata objects. The uniqueQueryMarkers collection is constructed, followed by the uniqueQueryMarkerSets, the uniquePeriodSets, and the uniqueQueries collections. The uniquecounter variable is initialized to 1. Each of these collection objects is explained in detail when they are actually used in the process. This step is only constructing the empty collections. The QueryDetector constructor returns control to the Run method.

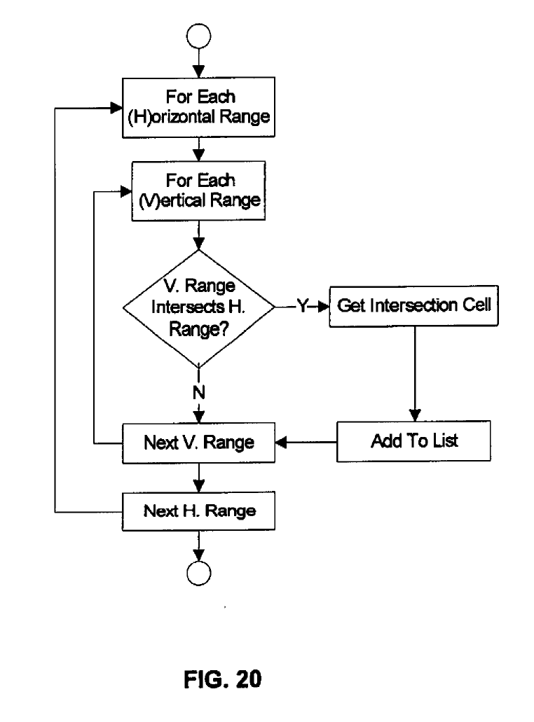

The next group of steps of the read process sequence illustrated in FIG. 19 relates to analyzing and processing the metadata. The Run method calls the FindIntersectionCells method on the QueryDetector object. ReportSheet passes FindIntersectionCells a reference to the rangeList collection of ShadowRanges. This allows the QueryDetector to analyze the list to find intersection cells. A “cells collection” is constructed. This collection keeps track all of the JunctionCell objects which are assigned to the intersection cells found by this method. The ShadowRanges in the rangeList are split into two groups: one for horizontal ranges and one for vertical ranges. Two internal collection variables are used to store references to each set of ShadowRanges. This is done by checking a standard EXCEL object model Count property on the xlRange object stored in the ShadowRange. If xlRange.Columns.Count equals one and xlRange.Rows.Count is not equal to one, and xlRange.Areas.Count equals one then this ShadowRange object is a vertical (columnar) range and is added to the vertical range collection. Otherwise it is added to the horizontal range collection. (Note that if both xlRange.Columns.Count were equal to one, and xlRange.Rows.Count were equal to one, this would denote a single cell.) By iterating through the horizontal and vertical ranges, intersection cells on the worksheet are identified by calling a standard Excel object model Intersect method passing it the two ranges to be checked. At the end of the process, MDD values will be inserted into the identified intersection cells. Each horizontal range is checked against each vertical range in a second loop, as illustrated in FIG. 20.

A JunctionCell object (FIG. 12) is instantiated for every valid intersection cell. The JunctionCell constructor is passed a reference to the EXCEL range and the horizontal and vertical range to which the intersection cell belongs. The hRange, vRange, and xlRange variables to the parameters passed in to the JunctionCell constructor, which also initializes other variables in the JunctionCell object. The dimMarkers collection is constructed and the timeFieldMarker variable is initialized to null. The HoldOntoMarkers function is called twice; once for the horizontal range markers collection and once for the vertical range markers collection. The HoldOntoMarkers function is passed the markersList collection from the range collection. It then iterates though all of the Marker objects passed to it and splits the markers by sub-class type. It ignores any DimensionMarker objects that have the dimQueryType set to Rollup Dimension effectively ignoring this dimension when building the database query later in the process. Any DimensionMarker objects with dimQueryType set to anything besides Rollup Dimension are put into the dimMarkers collection. If a marker is a TimeFieldMarker, the reference is copied into the timeFieldMarker variable. The process does not need a collection to store TimeFieldMarker types because there can at most be only one for a single JunctionCell. It is also possible to have no TimeFieldMarker types in either the horizontal range collection or the vertical range collection if the report sheet itself is built to include time field at the report sheet level.

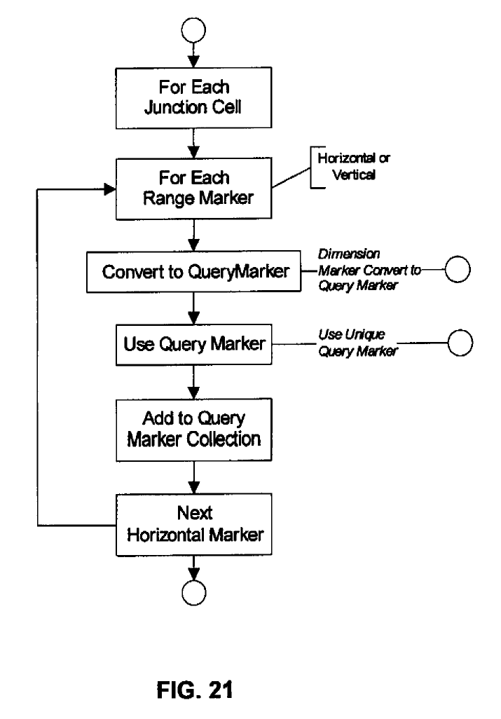

The dimMarkers collection is sorted (which helps with optimization of searches and comparisons later in the process). The JunctionCell constructor returns control to the FindIntersectionCells method. The newly created JunctionCell object is added to the cells collection for the entire report sheet as well as the intersectionCells collection in both the horizontal and vertical ranges in which the intersection cell resides. The FindIntersectionCells method returns control to the Run method returning the complete cells collection. This collection of JunctionCells is stored at the ReportSheet (FIG. 5) level in the cellList collection. The Run method calls SetupUniqueQueryMarkers, which starts a sub-process to generate unique QueryMarkers across the entire cells collection for all horizontal and vertical ranges in the ReportSheet. This is required in order to minimize the number of database queries generated in a later step which will combine result sets. This sub-process is illustrated by the flowchart of FIG. 21.

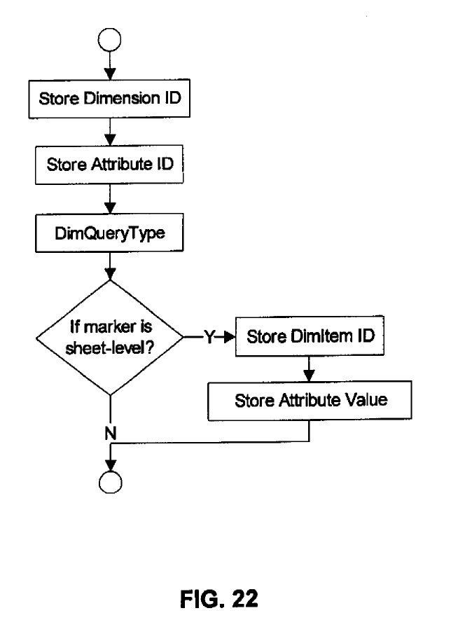

With reference to FIG. 21, each JunctionCell in the cells collection iterates through each of its vertical and horizontal Marker objects, converting them to QueryMarker objects. Each Marker object is converted to a QueryMarker by calling the abstract base method ConvertToQueryMarker on the Marker object. There are separate implementations of the ConvertToQueryMarker method in each of the two sub classes (DimensionMarker and TimeFieldMarker), allowing it to be called polymorphically. When the TimeFieldQueryMarker is created, it just stores the year from the TimeFieldMarker. Primarily, as illustrated in FIG. 22, DimensionQueryMarker stores dimensionID, attributeID, and dimQueryType. For DimensionMarkers that apply to the entire report sheet, it additionally stores dimItemID and attributeValue, which helps reduce the size of the result set returned from the database after running the queries.

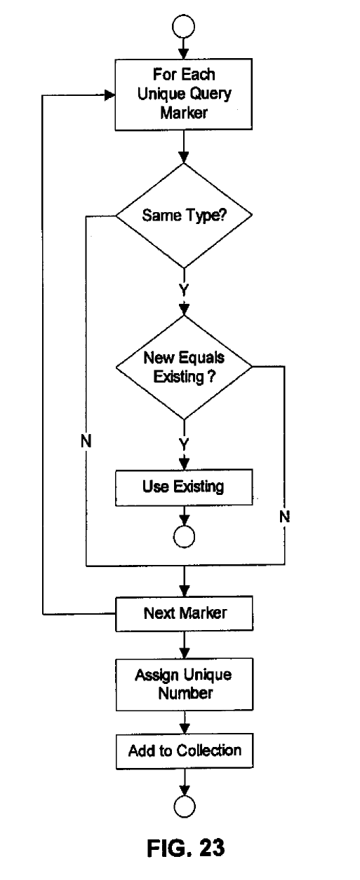

As illustrated in FIG. 23, the process compares the newly created QueryMarker object to existing QueryMarkers in the uniqueQueryMarkers collection for uniqueness to build distinct sets of QueryMarkers. This in turn assists in building the minimum number of database queries needed to acquire the MDD values in later steps.

With reference to FIG. 23, a new QueryMarker matches an existing QueryMarker, it is discarded. Otherwise it is assigned a unique ID and added to the uniqueQueryMarkers collection. First, unique numbers are generated by using the uniquecounter variable that was initialized in an above-described step. Each new QueryMarker object is assigned the current value of uniquecounter. Then, it is incremented by 1 in preparation for the next QueryMarker. The unique QueryMarker object is also added to the queryMarkers collection in the JunctionCell. Once all horizontal and vertical Markers for the JunctionCell have been processed, the processing on this JunctionCell is finished and the algorithm moves to the next JunctionCell. Once all JunctionCells have been processed, control is returned to the Run method in the ReportSheet object.

The next group of steps in the read process relates to building database-select queries using the results from the above-described metadata analysis. The Run method calls the BuildQueries method on the QueryDetector object. ReportSheet passes BuildQueries a reference to the paramList collection of Markers. Up to this point, the process has not needed the report sheet level metadata; however, generating database queries requires that all necessary information be evaluated. BuildQueries starts by again iterating through all the JunctionCell objects in the cells collection with the purpose of creating distinct sets of QueryMarkers that will directly translate into distinct database queries. These distinct sets are based on ShadowRange metadata; later steps in the process will use the metadata from the report sheet level.

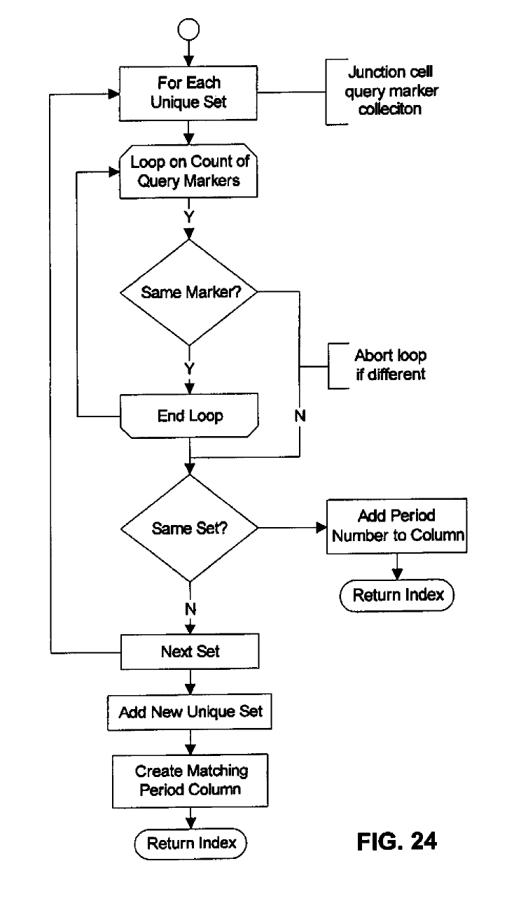

With the already existing distinct QueryMarkers, the process is able to create distinct QueryMarkers sets in order to combine like MDD values. Many cells have values that are very similar in terms of their dimensional or time relationships, which can all be retrieved from the database in one query. This part of the process determines which JunctionCells can be combined and which have to be retrieved by different database queries. In each iteration of the cells collection loop, the queryMarker collection for each JunctionCell is sorted by the uniqueID given to the QueryMarker at construction. Sorting the queryMarker collection simplifies the comparison of this list to other lists later in the process. For two lists to be identical, all QueryMarker objects in each collection must be identical. Sorted lists allow the collections to be walked by index and inequality is easily determined when any two items are not equal. As illustrated in FIG. 24, a double nested loop is started in order to determine if the queryMarker collection for this JunctionCell is unique or already exists by comparing it to already existing QueryMarker sets in a collection called uniqueQueryMarkerSets (see FIG. 13). The outer loop walks each collection of QueryMarkers in the uniqueQueryMarkerSets collection. The inner loop compares each QueryMarker in the queryMarker collection by index to each QueryMarker object in the current unique set from the outer loop. (This works because the process sorted the list first, in a step described above.)

Each QueryMarker object in the JunctionCell's queryMarker collection is compared to the QueryMarkers in all already existing unique sets by reference because, in previous steps, the process eliminated the possibility of duplicates. If all QueryMarker objects in the JunctionCell's queryMarker list are found to match an existing set, then the periodNum for this JunctionCell is added to a set of periodNums stored in the uniquePeriodSets collection, which corresponds to the unique QueryMarker set. This allows a unique query to pull back MDD values for many periods in one query. If the JunctionCell's queryMarker collection does not match any existing unique QueryMarker set, then the algorithm has found a new unique set and it is added to the uniqueQueryMarkerSets collection. A new collection, periodsNums, is created and the periodNum for this JunctionCell is added to this collection. This periodNums collection corresponds to the new unique QueryMarker set and tracks all of the distinct period numbers that will be pulled from the database. The collection of periodNums needs to be unique to reduce redundancy when generating database queries later in the process. The collection of periodNums is stored in the uniquePeriodSets variable. Each collection of periodNums is ordered in the uniquePeriodSets variable in the same order as the QueryMarker collections in the uniqueQueryMarkerSets variable. This allows the two collections to be related later. The index of the QueryMarker collection, retrieved from the uniqueQueryMarkerSets collection, is stored in both the horizontal and vertical ShadowRange objects that contain this JunctionCell. This list, which does not allow duplicates, is called queryIndexList in the ShadowRange object (FIG. 6).

At this point, the QueryMarker objects for the ShadowRanges have been created. Now the process incorporates the ReportSheet metadata to create ReportSheet level QueryMarker objects. The ReportSheet Marker objects are converted to QueryMarker objects just like ShadowRange Marker objects. (See above-described step relating to how Markers are converted to QueryMarkers.) Note that the conversion of DimensionMarker objects for ReportSheet metadata take the alternate flow path in FIG. 22 by answering “Yes” to the “Is Marker sheet level?” question. The two additional pieces of information DimItemID and AttributeValue are maintained in the DimensionQueryMarker for sheet level objects because this information will be the same across all of the distinct sets found above.

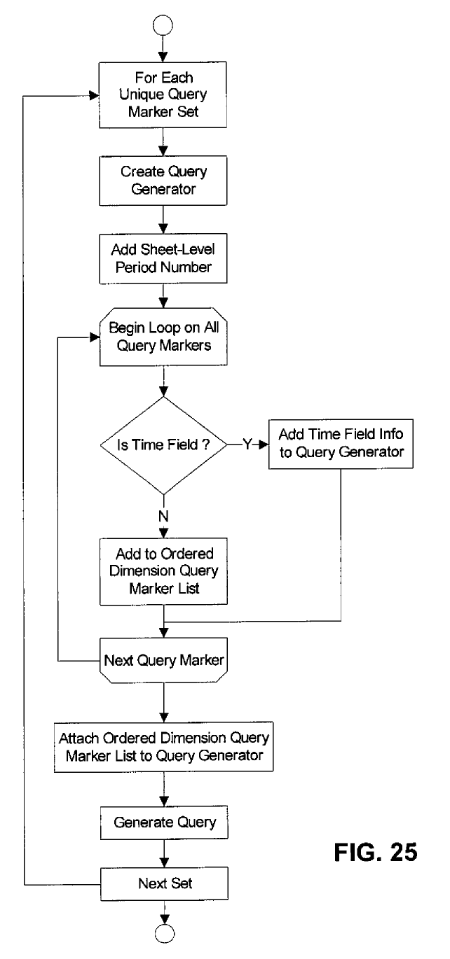

A loop is started to build a SQL query string for each set of QueryMarker objects in uniqueQueryMarkerSets. As each query is built, it is stored in a collection in the QueryDetector object (FIG. 13) called uniqueQueries. The query strings are stored in the same order as the objects in uniqueQueryMarkerSets to allow matching between the different lists, as shown in FIG. 25.

With reference to FIG. 25, the QueryDetector creates an instance of the QueryGenerator object, a helper class that encapsulates process logic to manipulate strings to build the dynamic queries. The index of the current set of QueryMarkers is acquired allowing the process to later index the uniquePeriodSets collection. (The fact that it was sorted in an above-described step makes this possible.) The correct collection of periodNums is pulled from the uniquePeriodSets variable using the index value acquired in the previous step. If a TimeFieldMarker was assigned at the sheet level, the periodNum in that TimeFieldMarker is added into the collection of periodNums in the same manner as described above with regard to a previous step of creating a periodsNums collection. The collection of period numbers is converted into a comma delimited string (e.g. “1, 2, 3”) in preparation to append it to the SQL query string generated in a later step. Another loop is started on each QueryMarker object in the current set (obtained via the above-described loop in FIG. 25 for building a SQL query string from the uniqueQueryMarkerSets variable) to separate out the two types of QueryMarkers and handle each according to its function.

If the QueryMarker is a TimeFieldQueryMarker, the year property in the QueryGenerator object is set to the year in the TimeFieldQueryMarker. Because there can only be one TimeFieldQueryMarker in all the QueryMarker objects in either the set from uniqueQueryMarkerSets or the set from the sheet level information, it is appropriate to set the year information in the QueryGenerator at this point in the process. If the QueryMarker is a DimensionQueryMarker, it is added into an internal collection of DimensionQueryMarkers (in the QueryDetector object) that applies to the specific query being built in this iteration of the above-described loop in FIG. 25. The DimensionQueryMarker objects are stored in numerical order based on the dimensionID in the DimensionQueryMarker (FIG. 16). This order is enforced because the dynamic SQL query will be built using this order and the column order of the result set from this query will also match this order allowing code later in the process to identify the correct columns when placing the MDD values into the worksheet.

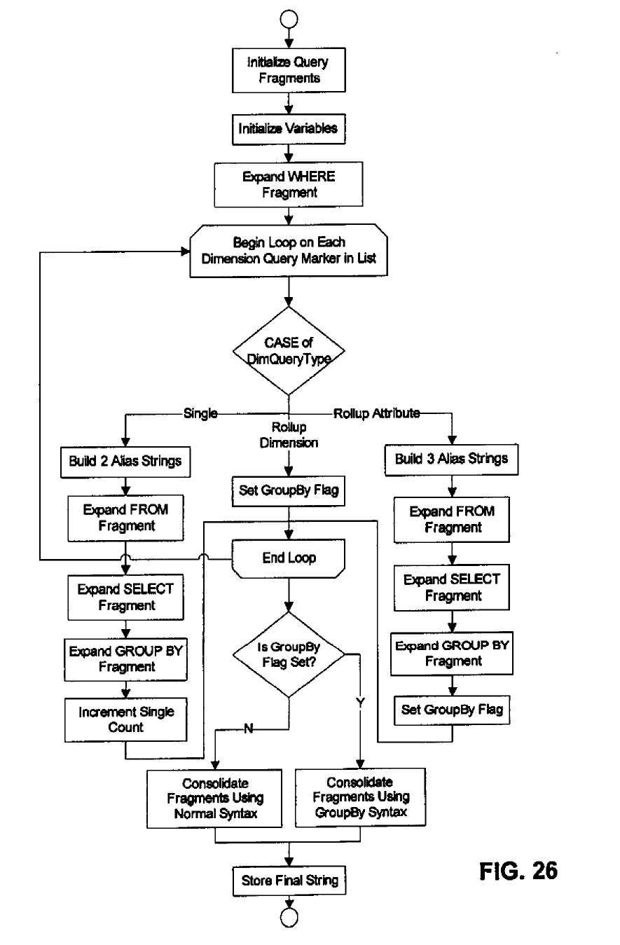

Once all QueryMarker objects in the current set from uniqueQueryMarkerSets have been processed, another loop, identical to the above-described step in which another loop is started on each QueryMarker object in the current set, operates against the QueryMarker collection from the sheet level that was created as described above. The steps at which the year property in the QueryGenerator object is set to the year in the TimeFieldQueryMarker and at which QueryMarker is added into an internal collection of DimensionQueryMarkers are also executed against this collection. After this loop is finished, the QueryGenerator object contains the time field information, regardless if it came from the uniqueQueryMarkerSets collection or the report sheet collection and the internal collection of DimensionQueryMarkers contains all of the DimensionQueryMarker objects from both the uniqueQueryMarkerSets collection and the report sheet collection. All of the DimensionQueryMarker objects in the internal collection are given to the QueryGenerator object in order by calling the AddDimension method on the QueryGenerator object. The QueryGenerator method GenerateQuery is called, passing the above-described comma-delimited string of period numbers, building a SQL query string, as shown in FIG. 26.

The process builds a SQL string as many different pieces (or fragments) and then puts them together near the end of the process shown in FIG. 26. Each fragment is initialized with a starting value and appended with additional values using string manipulation as the query is built. The following are the SQL query fragment strings and an exemplary starting value for each:

a. selectQuery=“SELECT a.PeriodNum”

b. groupByQuery=“GROUP BY a.PeriodNum”

c. selectAddendum=“ ”

d. groupByAddendum=“ ”

e. fromQuery=“FROM DataValue a” (Given the alias ‘a’.)

f. whereQuery=“WHERE”

g. aggregateQuery=“, SUM(a.DataValue) AS DataValue”

h. nonAggregateQuery=“, a.DataValue”

Several variables needed in the GenerateQuery method are initialized. The aliasIndex variable is set to 1, the class level variable singleCount is set to 0, and the groupByFlag is set to false.

The aliasIndex variable is used to build table aliases that distinguish between different instances of the same database table being joined into the query multiple times. An alias is built using the string “alias” and appending incremented aliasIndex variable onto the end. This guarantees uniqueness in alias names.

The groupByFlag variable tells the last part of the method whether to build a “group by” style query or a straight non-aggregated “select” query. This may or may not be set depending on the dimQueryType of the different dimensions that make up this query.

The singleCount variable tracks the number of dimensions in this query that have the dimQueryType value of Single Dimensional Item. This value is used later in the “Place MDD Values in Correct Worksheet Cells” section.

The whereQuery fragment is expanded. For example:

“Year=”

### Appended to the fragment shown above is the actual year value that was given to the QueryGenerator object at the step described above relating to setting the year property in the QueryGenerator object to the year in the TimeFieldQueryMarker.

With continuing reference to FIG. 26, a loop is started on each DimensionQueryMarker in the collection stored in QueryGenerator. Each DimensionQueryMarker object is processed according to its dimQueryType (e.g., using a “case” statement or similar multi-way software construct). The following describes how each object is processed according to its query type, i.e., the various possible cases of dimQueryType.

A query type of Rollup Dimension dictates that all MDD values for this dimension are summed together in the result set. The groupByFlag is set. Nothing is added to any of the query fragments effectively ignoring this dimension when the query is run. The query will use a “group by” SQL syntax which takes care of aggregating this dimension.

A query type of Single Dimensional Item dictates that this dimension is limited to single dimensional items. Two unique alias strings are built. The fromQuery fragment is expanded to join to two additional database tables. For example, the following can represent join operations on two database tables:

### “INNER JOIN DataValueDimItem alias1 ON alias1.DataValueID=a.DataValueID”

### “INNER JOIN DimItem alias2 on alias2.DimItemID=alias1.DimItemID AND alias2.DimensionID=X”

Thus, in the exemplary table join operations shown above, the X is replaced with the DimensionID variable stored in the DimensionQueryMarker. If this DimensionQueryMarker is a sheet level marker, an additional string is appended to the string of the second database table shown above. This includes the additional information stored for sheet level markers as described above with regard to the step of incorporating the ReportSheet metadata to create ReportSheet level QueryMarker objects. For example:

### “AND alias2.DimItemID=X”

Thus, the X is replaced with the DimItemID. Note with regard to such additional sheet-level information that the database queries are built to keep like sets of data together; that is, values that can be returned in the same “group by” clause from the database are combined into one query. However, at the same time, the queries are designed to return a data set that is limited to just the required values. By appending clauses into the query that fully qualify the sheet level dimension; the process eliminates extraneous values that would otherwise bloat the result set.

The selectQuery fragment is then expanded. For example:

“,alias2.DimItemID AS DimXDimItemID”

Thus, the X is replaced with the DimensionID in the DimensionQueryMarker. The selectAddendum fragment is also expanded. For example:

“,alias2.DimItemName AS DimXDimItemName”

Thus, the X is replaced with the DimensionID in the DimensionQueryMarker. This part of the select statement is kept in a separate fragment because the DimItemName is not required to make this query work and is included only for clarity. It is combined onto the select statement as part of the final processing of the string near the bottom of this process to move this column further out in the order so processing the result set will be easier. Later algorithms assume the first few columns of a result set are the primary key so having a non-necessary name column would throw off this code.

The groupByQuery fragment is also expanded. For example:

“,alias2.DimItemID”

Even though the Single Dimensional Item case does not by itself require the SQL “group by” syntax, other DimensionQueryMarkers might, so if the query as a whole turns out to be a “group by” query, this DimItemID must be one of the columns grouped. The groupByAddendum fragment is also expanded. Again, this is non-necessary data included for clarity. For example:

“,alias2.DimItemName”

### Because this DimensionQueryMarker is of dimQueryType Single Dimensional Item the singleCount variable is incremented.

A query type of Rollup Attribute dictates that this dimension will aggregate individual dimensional items up into combination values or rollups. Three unique alias strings are built. The fromQuery fragment is expanded to join to three additional database tables. For example, the following can represent join operations on three database tables:

### “INNER JOIN DataValueDimItem alias1 ON alias1.DataValueID=a.DataValueID”

### “INNER JOIN DimItem alias2 on alias2.DimItemID=alias1.DimItemID AND alias2.DimensionID=X”

### (Note that in this second table the X is replaced with the DimensionID variable stored in the DimensionQueryMarker.)

### “INNER JOIN AttributeValue alias3 ON alias3.DimItemID=alias2.DimItemID AND alias3.AttributeID=X”

Note that in this third table the X is replaced with the AttributeID stored in the DimensionQueryMarker. If this DimensionQueryMarker is a sheet level marker, an additional string is appended to the string in the third table. This includes the additional information stored for sheet level markers in the above-described step relating to incorporating the ReportSheet metadata to create ReportSheet level QueryMarker objects. For example:

### “AND alias3.AttributeValue=X”

Thus, the X is replaced with the AttributeValue, as noted above with regard to sheet-level additional information. The selectQuery fragment is then expanded. For example:

“,alias3.AttributeValue AS DimXAttributeValue”

Thus, the X is replaced with the DimensionID stored in the DimensionQueryMarker. The groupByQuery fragment is also expanded. For example:

“,alias3.AttributeValue”

Now the groupByFlag is set. Once all of the DimensionQueryMarkers have been processed, the code can consolidate the final query for this QueryGenerator object. If the groupByFlag is true, then the fragments are consolidated in this order: selectQuery, selectAddendum, aggregateQuery, fromQuery, whereQuery, groupByQuery, groupByAddendum.

Finally, a last statement is appended. For example:

### “HAVING a.PeriodNum in (X)”

Thus, the X is replaced with the comma delimited string of period numbers passed to this method as described above. If the groupByFlag is false, then the fragments are consolidated in this order: selectQuery, selectAddendum, nonAggregateQuery, fromQuery, whereQuery. A last statement is likewise appended. For example:

### “AND a.PeriodNum in (X)”

Thus, the X is replaced with the comma delimited string of period numbers passed to this method as described above. Once the dynamic string query has been generated, it is stored internally in the QueryGenerator object for later use and the QueryGenerated object is added to the uniqueQueries collection referred to above with regard to the loop in which the SQL query string is built. Finally, control is returned to the ReportSheet object's Run method.

The next group of read process steps relates to executing the SQL queries to acquire results. First, the Run method calls the RunQueries method on the QueryDetector object. Then, RunQueries creates a DataSet object to house the results of each of the database queries. A loop in started to iterate through each QueryGenerator object in order. The SQL query string is retrieved from the QueryGenerator object and executed against the database. A DataTable object is returned and given a unique name by index starting at 1. Each resultant DataTable object is added into the DataSet object. Once all the queries have been run, the DataSet object is returned to the Run method. The DataSet object is kept in an internal variable in the SheetReport object for use as described below.

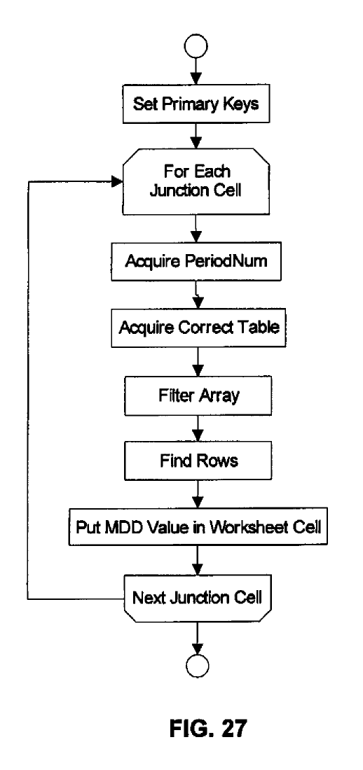

The next group of read process steps relates to placing MDD values in corresponding spreadsheet (e.g., EXCEL Worksheet) cells. First, the Run method calls an internal function called ExtractCellData. This method is responsible for pulling the specific MDD values out of the DataSet object and placing them into the correct cell in the EXCEL Worksheet, as shown in FIG. 27.

With reference to FIG. 27, ExtractCellData first sets up primary key columns on each DataTable object in the DataSet. Primary key columns should not contain columns that are sheet level because values in those columns will be identical for every row in the DataTable. Each Marker object in the sheet level collection paramList is processed in a loop. If it is a DimensionMarker and its dimQueryType is not Rollup Dimension, then the next two steps are executed. The names of two columns are stored in a collection of names to exclude from the primary key columns. DimXDimItemID and DimXAttributeValue. X is replaced with the DimensionID in the DimensionMarker. These two column names should not be part of the primary key on any table. An internal variable called numSheetLeveIDimensions is incremented that tracks how many of the sheet level markers fall into this category.

Once the above-described loop is finished in which each Marker object in the sheet level collection paramList is processed, the primary key columns can be built for each DataTable. Each DataTable will have a different number of columns, so table specific information is gathered for each. A loop is started to process each DataTable in the DataSet. The number of primary key columns for the current DataTable is calculated. Initially, this number is the same as the number of columns in the DataTable. One is subtracted from the number for the DataValue column. (This is the column that has the actual MDD value.) The singleCount variable that was set as described above is subtracted because the (possibly multiple) DimItemName column(s) are unnecessary. The numSheetLevelDimensions is subtracted off as well for reasons described above with regard to setting up primary key columns on each DataTable object in the DataSet. This gives the count of columns that will be included in the primary key.

To build an internal array of column objects, the process starts a loop. Beginning with the first column, each column is walked (up to the count calculated in the previous step) and is added to the internal array unless that column name is found in the collection of names to exclude. The DataTable's primary key is set to the array of columns found in the previous step using the DataTable's PrimaryKey property. After all primary key columns have been configured in each DataTable, the process starts a loop to process each JunctionCell in the ReportSheet cells collection in order to place an actual MDD value. The period number for this particular cell is found. The cell will have a value in the timeFieldMarker (FIG. 10) variable (set at the above-described step relating to calling the HoldOntoMarkers function), unless the time field was assigned at the sheet level. In that case, all the markers in the paramList collection is searched until the TimeFieldMarker is found. Once it is found, the TimeFieldMarker's PeriodNum is extracted. The DataSet contains multiple tables, which were inserted in the same order as the original uniqueQueryMarkerSets collection. (As described above, the indexes of queries independently in both the horizontal and vertical ShadowRange objects were stored in a previous step.) A JunctionCell can now correlate both the horizontal and vertical collections to find the single query index contained in both collections.) The DataTable in the DataSet with this index is retrieved.

To hold the filter values used to find a specific row in the DataTable object, the process declares an array of objects sized to the number of DimensionMarker objects that relate to this cell. The first object in this array is initialized with the period number found in the above-described step relating to finding the period number for the particular cell. The first column returned for every query is the PeriodNum. Because of three previous processes (ordering the dimMarkers by DimensionID, ordering the SQL query columns by DimensionID, and not storing markers of dimQueryType Rollup Dimension in dimMarkers), each successive object in the array is initialized with a value from each DimensionMarker in the JunctionCell's dimMarkers collection in order. The value set in the array is the DimItemID for Single Dimensional Item types and it is the AttributeValue for Rollup Attribute types.

The Rows.Find method is called on the DataTable found as described above with regard to a previous step. The array of objects is passed to this method. Because we set up primary keys on the columns in this table, the Find method return the exact row in the DataTable that contains the MDD value for this exact cell. The DataValue field value is pulled from the row and placed into the Excel cell. It is possible that the database does not contain a data value for this particular cell. In that case a value representing the null case is placed into the cell. For example: zero, the string “null”, or an empty string. The DataValue field is also placed into the originalvalue field in the JunctionCell. This allows for later comparisons between this original value and any possible changes in the EXCEL Worksheet. This process continues for every JunctionCell in the cells collection. Once all cells are processed, the read process is complete.

The Write Process

The write process, described above at an overview level with regard to steps 60, 62, 64 and 66 in FIG. 3, operates upon a combination of three things: a spreadsheet (e.g., EXCEL Worksheet) that contains MDD values that has already been filled with data via the read process steps described above; a database that conforms to the MDD model described above with regard to FIG. 18 (and which need not contain existing data, as the write process handles both inserting new values and updating existing values); and metadata (including supporting metadata that was created during the read process).

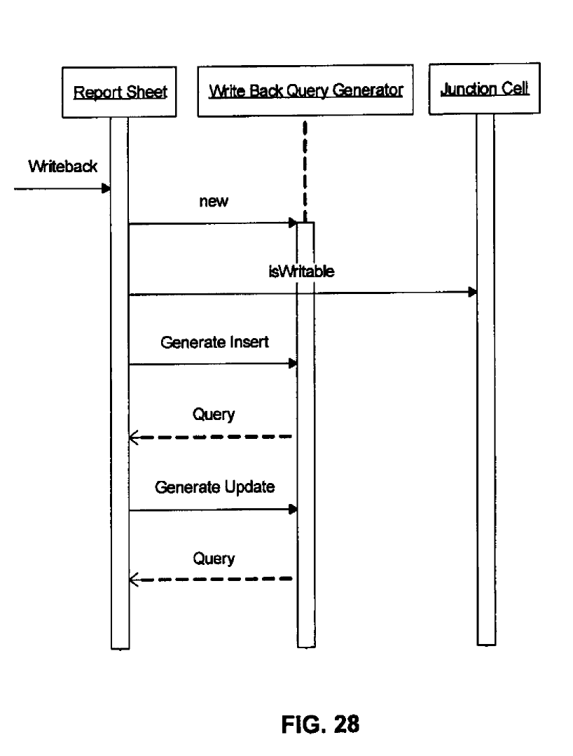

The write process follows these sequential steps to complete its function. An exemplary write process is illustrated by the sequence diagram of FIG. 28. The read process starts when the WriteBack method of the ReportSheet object (FIG. 5) is executed. This method controls the process. When the WriteBack method finishes, the entire write process algorithm is complete. Because much of the already accumulated metadata is reused by the write process, the write algorithm is much shorter than the read process algorithm. A new instance of a class called WriteBackQueryGenerator is created. WriteBackQueryGenerator is a helper class that encapsulates process logic to manipulate strings to build the dynamic insert and update queries.

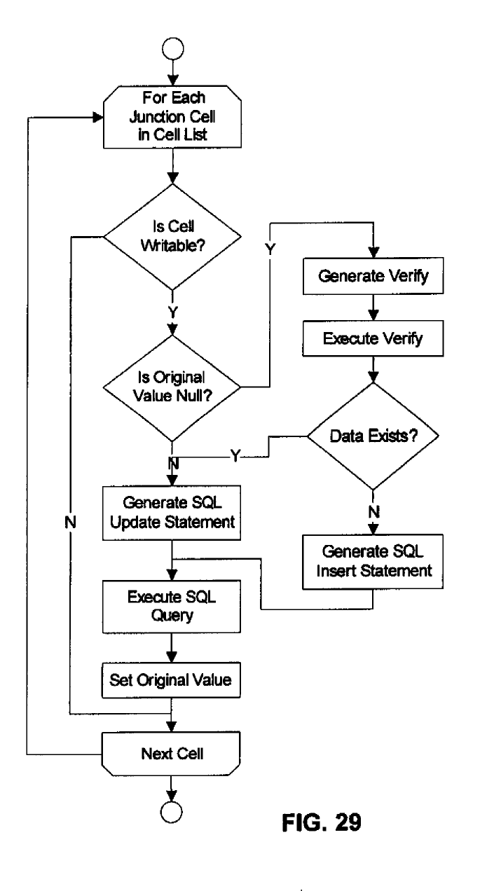

The next group of steps of the write process illustrated in FIG. 28 relates to analyzing and processing the metadata. A loop is started that iterates over every JunctionCell object (FIG. 12) contained in the cellList collection in the ReportSheet object. A flow chart diagram for this loop is illustrated in FIG. 29.

With reference to FIG. 29, each junction cell is processed. The JunctionCell object's is Writable property is checked to determine the JunctionCell's writable status. The is Writable function checks all of the DimensionMarkers objects in both the horizontal and vertical ranges for this JunctionCell. Specifically, if the dimQueryType is Single Dimensional Item, is Writable returns true. Otherwise, is Writable returns false. Only non-aggregate data values can be written back to the database. If the is Writable property returns false, then this cell cannot be written and is skipped. If the is Writable property returns true, the JunctionCell's originalvalue is compared to the null case. If it does not equal, then an update query must be generated, as described below with regard to the step of calling the GenerateUpdate method on WriteBackQueryGenerator. If it equals, there is still a remote possibility that the database was modified since the original read. A double check is needed to make sure the value for this cell does not exist in the database. The GenerateVerify method on WriteBackQueryGenerator is called. This method dynamically builds a select query for this specific cell. If a value exists in the database, an update query must be generated, as described below with regard to the step of calling the GenerateUpdate method on WriteBackQueryGenerator. If a value does not exist, an insert query must be generated, as described below with regard to the step of calling the GenerateInsert method on WriteBackQueryGenerator. The GenerateVerify method takes the JunctionCell object and the paramList collection as parameters. A SQL query string fragment is started and initialized. For example:

### “SELECT count(*) FROM DataValue a”

Each DimensionMarker in the JunctionCell object and in the paramList collection is processed, and a query fragment is added to the initial string. For example:

### “Join DataValueDimItem alias ON alias.DataValueID=a.DataValueID AND alias.DimItemID=Y”

### Thus, the Y is replaced with the DimItemID from the DimensionMarker object.

After all the DimensionMarkers have been processed, a “WHERE” clause is appended into the query fragment string. For example:

### “WHERE Year=X AND PeriodNum=Y”

### Thus, both X and Y are replaced with the year and PeriodNum from the TimeFieldMarker for this JunctionCell, respectively.

The next group of write process steps relates to building a database insert query or a database update query. The GenerateInsert method on WriteBackQueryGenerator is called. The GenerateInsert method takes the JunctionCell object and the paramList collection as well as the new value to insert as parameters. A SQL query string fragment is started and initialized. For example:

### “INSERT INTO DataValue (Year, PeriodNum, DataValue) VALUES (X, Y, Z)”

Thus, the X is replaced with the year from the TimeFieldMarker in the JunctionCell object. Y is replaced with the PeriodNum from the TimeFieldMarker in the JunctionCell object. Z is replaced with the new value to be inserted.

Then, a query along the lines of the following example is appended to insert the necessary DataValueDimItem rows:

### “Declare @id int SELECT @id=SCOPE_IDENTITY( ) INSERT INTO DataValueDimItem (DataValueID, DimItemID) SELECT @id, DimItemID FROM DimItem WHERE DimItemID IN (”

Each DimensionMarker in the JunctionCell object and in the paramList collection is processed and a query fragment is added to this string. In this case it is the DimItemID from the DimensionMarker object followed by a comma. A final close parentheses is added “)”, and the database insert query is complete.

Next, the GenerateUpdate method on WriteBackQueryGenerator is called. The GenerateUpdate method takes the JunctionCell object and the paramList collection as well as the new value to update as parameters. A SQL query string UPDATE fragment is started and initialized. For example:

### “UPDATE DataValue SET DataValue=X FROM DataValue a”

### Thus, the X is replaced with the new value to update.

A WHERE query fragment is started. It pulls data from the TimeFieldMarker object in the JuctionCell object; specifically the year and PeriodNum fields.

### “WHERE Year=X AND PeriodNum=Y”

Each DimensionMarker in the JunctionCell object and in the paramList collection is processed, and a new JOINS query fragment is built.

### “JOIN DataValueDimItem ON alias.DataValueID=a.DataValueID AND alias.DimItemID=X”

### Thus, the X is replaced with the DimItemID from the DimensionMarker object.

The final query is concatenated together in this order: UPDATE fragment, JOINS fragment, WHERE fragment. This completes the update query.

The final write process step relates to executing the query to persist the data to the database, i.e., store the data in the database. Regardless of whether the query is an update or an insert query, it is executed against the database. The JunctionCell's originalvalue is reset to be the same as what was just written. This process continues for every JunctionCell in the cellList collection. Once all cells are processed, the write process is complete.

As described above with regard to FIG. 3, the read and write processes form the bases for range-based tracking (RBT) software 38 (FIG. 2) that enables a user to use a conventional spreadsheet application program 42, such as MICROSOFT EXCEL, to access multi-dimensional data (MDD) in relational database system 44. As noted above, the data is not stored in any intermediary data storage structure but rather is transferred directly between database system 44 and spreadsheet application program 42. In a multi-user environment, such as that of a large business enterprise, this absence of intermediate steps and storage structures enables all users to have near-instantaneous access to the same multi-dimensional data. As spreadsheet application programs 42 such as MICROSOFT EXCEL are ubiquitous in business environments, ordinary business users and others who do not have specialized database software skills but are comfortable using a spreadsheet can readily access data that would otherwise require the assistance of a database administrator or unfamiliar application program.

It is to be understood that the present invention is not limited to the specific devices, software, structures, methods, conditions, parameters, etc., described and/or shown herein, and that the terminology and notation (e.g., UML) used herein are for the purpose of describing particular embodiments of the invention by way of example only. For example, various other arrangements of software elements, which can be based in other suitable frameworks, programming languages, algorithms, logic, programming paradigms, etc., will occur readily to persons skilled in the art in view of the teachings herein. In addition, any methods or processes set forth herein are not intended to be limited to the sequences or arrangements of steps set forth but also encompass alternative sequences, which can include more steps or fewer steps, arranged in any suitable manner, unless expressly stated otherwise. With regard to the claims, no claim is intended to invoke the sixth paragraph of 35 U.S.C. Section 112 unless it includes the term “means for” followed by a participle.

What is claimed is:

1. A computer-implemented method for accessing a relational database via a spreadsheet, comprising:
retrieving predetermined metadata relating database organization to spreadsheet organization;
identifying data elements in the database corresponding to data elements in the spreadsheet in response to the metadata; and
accessing the identified data elements in the database to transfer information directly between the spreadsheet and the database.

2. The method claimed in claim 1, wherein the spreadsheet is MICROSOFT EXCEL.

3. The method claimed in claim 1, wherein the step of accessing data elements in the database comprises:
retrieving information from the database; and
displaying information on the spreadsheet in response to the retrieved information.

4. The method claimed in claim 3, wherein:
the metadata defines horizontal and vertical ranges corresponding to data-containing spreadsheet intersection cells; and
the step of identifying data elements in the database corresponding to data elements in the spreadsheet in response to the metadata comprises:
identifying the intersection cells in response to the horizontal and vertical ranges; and
generating at least one SQL query in response to identified intersection cells; and
the step of accessing the identified data elements in the database to transfer information directly between the spreadsheet and the database comprises:
executing the SQL query against the database to obtain information read from the database; and
inserting information into the spreadsheet intersection cells in response to the obtained information.

5. The method claimed in claim 4, wherein the step of generating at least one SQL query comprises determining a minimum number of SQL queries needed to obtain information to fill the intersection cells.

6. The method claimed in claim 4, wherein the step of inserting information into the spreadsheet intersection cells in response to the obtained information comprises determining from the metadata whether to aggregate information obtained from a plurality of database data elements into fewer intersection cells than data elements accessed.

7. The method claimed in claim 1, wherein the step of accessing data elements in the database comprises:
retrieving information displayed on the spreadsheet; and
storing information in the database in response to the retrieved information.

8. The method claimed in claim 7, wherein:
the metadata defines horizontal and vertical ranges corresponding to data-containing spreadsheet intersection cells; and
the step of identifying data elements in the database corresponding to data elements in the spreadsheet in response to the metadata comprises:
identifying the spreadsheet intersection cells in response to the horizontal and vertical ranges; and
generating at least one SQL query in response to identified intersection cells; and
the step of accessing the identified data elements in the database to transfer information directly between the spreadsheet and the database comprises:
obtaining information from the spreadsheet intersection cells; and
executing the SQL query against the database to write information to the database in response to the obtained information.

9. The method claimed in claim 8, wherein the step of generating at least one SQL query comprises determining a minimum number of SQL queries needed to store information obtained from the spreadsheet intersection cells.

10. A computer program product for accessing a relational database via a spreadsheet, the computer program product comprising a computer-readable medium on which is recorded instructions capable of causing a computer to:
retrieve predetermined metadata relating database organization to spreadsheet organization;
identify data elements in the database corresponding to data elements in the spreadsheet in response to the metadata; and
access the identified data elements in the database to transfer information directly between the spreadsheet and the database.

11. The computer program product claimed in claim 10, wherein the spreadsheet is MICROSOFT EXCEL.

12. The computer program product claimed in claim 10, wherein instructions capable of causing a computer to access data elements in the database comprise instructions capable of causing a computer to:
retrieve information from the database; and
display information on the spreadsheet in response to the retrieved information.

13. The computer program product claimed in claim 12, wherein:
the metadata defines horizontal and vertical ranges corresponding to data-containing spreadsheet intersection cells; and
instructions capable of causing a computer to identify data elements in the database corresponding to data elements in the spreadsheet in response to the metadata comprise instructions capable of causing a computer to:
identify the intersection cells in response to the horizontal and vertical ranges; and
generate at least one SQL query in response to identified intersection cells; and
instructions capable of causing a computer to access the identified data elements in the database to transfer information directly between the spreadsheet and the database comprise instructions capable of causing a computer to:
execute the SQL query against the database to obtain information read from the database; and
insert information into the spreadsheet intersection cells in response to the obtained information.

14. The computer program product claimed in claim 13, wherein instructions capable of causing a computer to generate at least one SQL query comprise instructions capable of causing a computer to determine a minimum number of SQL queries needed to obtain information to fill the intersection cells.

15. The computer program product claimed in claim 13, wherein the instructions capable of causing a computer to insert information into the spreadsheet intersection cells in response to the obtained information comprise instructions capable of causing a computer to determine from the metadata whether to aggregate information obtained from a plurality of database data elements into fewer intersection cells than data elements accessed.

16. The computer program product claimed in claim 10, wherein the instructions capable of causing a computer to access data elements in the database comprise instructions capable of causing a computer to:
retrieve information displayed on the spreadsheet; and
store information in the database in response to the retrieved information.

17. The computer program product claimed in claim 16, wherein:
the metadata defines horizontal and vertical ranges corresponding to data-containing spreadsheet intersection cells; and
the instructions capable of causing a computer to identify data elements in the database corresponding to data elements in the spreadsheet in response to the metadata comprise instructions capable of causing a computer to:
identify the spreadsheet intersection cells in response to the horizontal and vertical ranges; and
generate at least one SQL query in response to identified intersection cells; and
the instructions capable of causing a computer to access the identified data elements in the database to transfer information directly between the spreadsheet and the database comprise instructions capable of causing a computer to:
obtain information from the spreadsheet intersection cells; and
execute the SQL query against the database to write information to the database in response to the obtained information.

18. The computer program product claimed in claim 17, wherein the instructions capable of causing a computer to generate at least one SQL query comprises instructions capable of causing a computer to determine a minimum number of SQL queries needed to store information obtained from the spreadsheet intersection cells.

19. A system for accessing a relational database via a spreadsheet, comprising:
a database; and
a processor system programmed or configured to run a spreadsheet application program and:
retrieve predetermined metadata relating database organization to spreadsheet organization;
identify data elements in the database corresponding to data elements in the spreadsheet in response to the metadata; and
access the identified data elements in the database to transfer information directly between the spreadsheet and the database.

20. The system claimed in claim 19, wherein the spreadsheet is MICROSOFT EXCEL.

21. The system claimed in claim 19, wherein the processor system is programmed or configured to access data elements in the database by being programmed or configured to:
retrieve information from the database; and
display information on the spreadsheet in response to the retrieved information.

22. The system claimed in claim 21, wherein:
the metadata defines horizontal and vertical ranges corresponding to data-containing spreadsheet intersection cells; and
the processor system is programmed or configured to identify data elements in the database corresponding to data elements in the spreadsheet in response to the metadata by being programmed or configured to:
identify the intersection cells in response to the horizontal and vertical ranges; and
generate at least one SQL query in response to identified intersection cells; and
the processor system is programmed or configured to access the identified data elements in the database to transfer information directly between the spreadsheet and the database by being programmed or configured to:
execute the SQL query against the database to obtain information read from the database; and
insert information into the spreadsheet intersection cells in response to the obtained information.

23. The system claimed in claim 22, wherein the processor system is programmed or configured to generate at least one SQL query by being programmed or configured to determine a minimum number of SQL queries needed to obtain information to fill the intersection cells.

24. The system claimed in claim 22, wherein the processor system is programmed or configured to insert information into the spreadsheet intersection cells in response to the obtained information by being programmed or configured to determine from the metadata whether to aggregate information obtained from a plurality of database data elements into fewer intersection cells than data elements accessed.

25. The system claimed in claim 19, wherein the processor system is programmed or configured to access data elements in the database by being programmed or configured to:
retrieve information displayed on the spreadsheet; and
store information in the database in response to the retrieved information.

26. The system claimed in claim 25, wherein:
the metadata defines horizontal and vertical ranges corresponding to data-containing spreadsheet intersection cells; and
the processor system is programmed or configured to identify data elements in the database corresponding to data elements in the spreadsheet in response to the metadata by being programmed or configured to:
identify the spreadsheet intersection cells in response to the horizontal and vertical ranges; and
generate at least one SQL query in response to identified intersection cells; and
the processor system is programmed or configured to access the identified data elements in the database to transfer information directly between the spreadsheet and the database by being programmed or configured to:
obtain information from the spreadsheet intersection cells; and
execute the SQL query against the database to write information to the database in response to the obtained information.

27. The system claimed in claim 26, wherein the processor system is programmed or configured to generate at least one SQL query by being programmed or configured to determine a minimum number of SQL queries needed to store information obtained from the spreadsheet intersection cells.
